(19) United States
(12) Patent Application Publication
(10) Pub. No.: US 2010/0083687 A1
(43) Pub. Date: Apr. 8, 2010

(54) REFRIGERATOR AND FROZEN FOOD PRESERVATION METHOD

(75) Inventors: Masumi Handa, Tokyo (JP); Toshie Hiraoka, Tokyo (JP); Isamu Hirashiki, Tokyo (JP); Kiyoshi Yagita, Tokyo (JP); Mariko Matsumoto, Tokyo (JP); Katsumasa Sakamoto, Tokyo (JP); Go Maeda, Tokyo (JP); Kaori Ono, Tokyo (JP); Hisao Isaka, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-ku (JP)

(21) Appl. No.: 12/526,616

(22) PCT Filed: Dec. 5, 2007
(86) PCT No.: PCT/JP2007/073442

§ 371 Date: Dec. 22, 2009

(30) Foreign Application Priority Data
Apr. 17, 2007 (JP) 2007-108680
Jul. 20, 2007 (JP) 2007-189550

(51) Int. Cl. F25D 17/06; F25D 13/00; G05D 7/00

(52) U.S. Cl. 62/419; 62/440; 700/282

(57) ABSTRACT

The present invention is to realize supercooled freezing as a method of enhancing the quality of frozen food with a simple arrangement by a method other than quick freezing. Further, the present invention is to obtain a refrigerator and a frozen food preservation method capable of realizing high quality freezing by a simple arrangement.

The refrigerator, which stores food making use of the cold air generated by a cooler 3, includes a supercooling case 81 for keeping the stored food in a supercooled state, in which the food is not frozen even at a temperature equal to or less than the freezing point of the food, for at least a predetermined period of time. The supercooling case 81 is composed of, for example, a lower case of two-stage type upper and lower cases disposed in a switching chamber 200 capable of being switched to a plurality of temperature zones.

### TECHNICAL FIELD

The present invention relates to a freeze preservation technology using supercooling and to a refrigerator (also referred to as freezing refrigerator) and a frozen food preservation method making use of the technology.

### BACKGROUND ART

It is known that when frozen food is defrosted, the quality of the food is deteriorated as compared with fresh food which is not frozen. In ordinary freezing, when food at a room temperature is placed in a space set to −18° C., the temperature of the food is cooled to the same temperature as the space after a predetermined time passes. When, the temperature is equal to or less than the freezing point of the food, the food is frozen. When the food is placed in a low temperature environment, it is gradually cooled from the surface thereof and finally the central portion thereof reaches to a peripheral temperature. At the time, since the temperature of the surface of the food is lowered first, a phenomenon arises in that the surface is frozen first. Accordingly, since the ice crystals, which are formed on the surface of the food, are enlarged while deriving the unfrozen water in the food, large needle-like crystals are created toward the central portion of the food. Since the large needle-like crystals break the intrinsic structure of food such as meat, fish, and the like, it is very difficult to restore the shape of the food to the state before the time when it is frozen.

It can be said how small ice crystals are made in freezing and how the intrinsic structure of food is prevented from being broken by ice crystals are means for improving quality of freezing in almost all the foods. Further, recent needs for home refrigerators are concentrated on “freezing” or “freeze preservation” by the change of a dietary life and a life style. This is also the same as to business-use refrigerators and the like. It is required to increase the capacity of a freezing chamber due to a tendency in that the freezing chamber is used more often because various types of frozen foods are made available and used in an large amount, foods are made ahead and preserved therein, foods are stocked therein, and the like. On the other hand, since there is a severe request for food quality, various improvements are devised to increase the quality of frozen foods.

There is known a quick freezing as a typical technology for realizing high quality freezing by solving the above problems. That is, a high quality freezing technology is typically the quick freezing. The quality of quick freezing is often evaluated by a method of comparing the amounts of drips flowing out from meat and the like when they are defrosted. The flowing-out amount of the drips greatly depends on the positions where ice crystals are created, the size of the ice crystals, and the like when food is frozen. When the size of the ice crystals is large, cells are broken thereby, and the flowing-out amount of the drips is increased in defrosting, thereby food quality is deteriorated. In contrast, when the ice crystals are small in size, the shape of cells are kept and the flowing-out amount of the drips is reduced in defrosting, thereby “flavor” of food is preserved.

A reason why the amount of drips flowing out from quick frozen food is small, that is, why small ice crystals are created in food resides in that the food is caused to quickly pass through a temperature zone of −1° C. to 5° C. which is a maximum ice crystal making zone. Creation of large ice crystals can be suppressed by reducing the period of time during which the food exist in the temperature zone, in which ice crystals are grown, as far as possible. Accordingly, the quick freezing is a means for suppressing creation of large ice crystals in food.

There is a conventional technology for performing quick freezing in a refrigerator by providing it with a quick freezing vessel, which has a metal plate on a bottom, and a cold air duct, which is disposed above the opening of the upper surface of the quick freezing vessel to eject cold air for cooling food in the quick freezing vessel, and installing the quick freezing vessel in a quick freezing chamber (refer to, for example, patent document 1).

However, the quick freezing is disadvantageous in several points. First, although it is said that the size of ice crystals tends to be reduced by the quick freezing, it can not be always said that small ice crystals are actually created up to the central portion of food. It is contemplated that when a food to be frozen has a certain degree of size, the surface of the food to which cold air is directly applied is rapidly cooled and small ice crystals are created. However, it is also contemplated that the temperature of the central portion of the food is not sufficiently reduced and the central portion remains in a maximum ice crystal making zone, thereby large ice crystals or needle-like ice crystals are created. Next, a large amount of energy is required to blow ultra cold temperature air in the quick freezing, which goes against energy saving. Further, it is necessary to install a large compressor with high performance to make the ultra cold temperature air, which is disadvantageous in cost.

A supercooled freezing technology is exemplified as a novel freezing technology of high quality for avoiding the problems of the quick freezing. The supercooled freezing means that when food is cooled under a specific cooling condition, it is not frozen even at a temperature equal to or less than the temperature of the freezing point of the food. Preserving the food in the supercooled state is advantageous in that cooling faults such as denatured protein, damage of a cell structure, and the like due to freezing can be avoided. Further, it is reported that when supercooled food is removed from a supercooled state by being forcibly applied with stimulation, the food is quickly frozen, and a resulting frozen state less damages a cell structure as compared with the conventional quick freezing technology in which food passes through the supercooled state, and thus the quality of the food is much less deteriorated (refer to, for example, patent document 2). In the food which is frozen through the supercooled state, since fine granular ice crystals are created to the food in its entirety in place of needle-shaped ice crystals, the cell structure is less damaged.

In the conventional supercooled freezing, there is supercooled freezing for creating a supercooled state by a method of performing a rapid cooling processing for cooling foods and the like (vegetable, fruits, meat, fish, and the like) from a room temperature up to the vicinity of the ice-freezing point (freezing point) thereof relatively rapidly and subsequently performing a slow cooling processing for cooling the foods at a gentle cooling speed of 0.01° C./h to 0.5° C./h up to the ice-freezing point or less (refer to, for example, patent document 3). Further, there is disclosed a method of making a freezing temperature equal to or less than an ordinary temperature by generating a static magnetic field in the space of a freezing chamber, continuously or intermittently irradiating an electromagnetic wave having a predetermined frequency, which is determined according to the field intensity of the static magnetic field, to a substance located in the static magnetic field, and lowering the freezing temperature of water by generating nuclear magnetic resonance to hydrogen atomic nucleus which constitute the water molecules contained in the substance (refer to, for example, patent document 4).

Patent Document 1: Japanese Unexamined Patent Application Publication No. 2005-83687 (pages 16-17, FIGS. 2 and 3)

Patent Document 2: Japanese Unexamined Patent Application Publication No. 2003-180314 (paragraph [0012])

Patent Document 3: Japanese Unexamined Patent Application Publication No. H8-252082 (claim 1, paragraph [0015])

Patent Document 4: Japanese Unexamined Patent Application Publication No. 2000-325062 (claim 1, paragraph [0014])

### DISCLOSURE OF THE INVENTION

### Problems to be Solved by the Invention

In the conventional technologies, since a cooling speed is slow to establish a supercooled state. Therefore, when the supercooled state continues too long, there is a possibility that the quality of food is deteriorated by oxidation, breeding of bacteria, and the like. Further, since the supercooled state is unstable, there is a problem in that supercooling is liable to be stopped before a lowest reach point temperature reaches to a deep (low) point in the supercooled state and that when the lowest reach point temperature is shallow (high), ice nucleuses made during stopping the supercooled state is small, so that freezing of good quality cannot be performed.

Further, when an excessively long time is taken from supercooling to freezing at the time when supercooled freezing is performed in a home refrigerator and the like, in which several types of foods are mixedly stored at the same time, the food, which was already frozen, is left in an environment, in which gentle freezing is performed, that is, in which a high temperature is kept, as it is for a long time. Thus, a problem arises in that the quality of the frozen food is adversely affected.

Further, the method of shifting to a gentle cooling after quick freezing up to the vicinity of the ice-freezing point is disadvantageous in a freezing chamber, in which foods having different ice-freezing points mixedly exist, in that it is very difficult to set an optimum shift point.

Further, Patent Document 2 discloses a method of placing foods (water, milk products, strawberries) in a supercooled state after they are subjected to a process for cooling them from a temperature higher than a freezing point to a temperature equal to or less than the freezing point at a cooling speed from −0.5° C./h to −5.0° C./h in the state that they are accommodated in a vessel in a sealed state without leaving a dead space therebetween. When this method is used, although it is possible to create the supercooled state at a cooling speed faster than a conventional speed, a troublesome job is required to seal the foods. Further, there is also a problem in that it is difficult to seal all the foods that may be preserved in a freezing chamber.

Further, a complex and large apparatus is required to create the supercooled state by the method of continuously or intermittently irradiating a substance located in a static magnetic field with an electromagnetic wave having a predetermined frequency, which is determined according to the intensity of the magnetic field in the static magnetic field, to lower the freezing temperature of the water in the substance by generating a nuclear magnetic resonance to the nucleuses of the hydrogen atoms constituting the water molecules contained in the substance, and set the freezing temperature to a temperature equal to or less an ordinary freezing temperature, and thus the method is not practical to foods. Even if the method is applied to a business-use refrigerated warehouse, the apparatus is excessively large in size and becomes too expensive, from which it is contemplated that it is practically more difficult to provide a home refrigerator with the apparatus. Further, attention is recently concentrated on a health damage due to an electromagnetic wave, from which a problem arises in that a sufficient caution must be paid to the influence of the electromagnetic wave to human bodies when the apparatus is applied to home, business-use and distribution refrigerators because the doors of them can be opened and closed simply.

An object of the present invention, which was made to solve the above problems, is to obtain a refrigerator and a frozen food preservation method which can freeze foods by a smaller amount of energy without damaging the quality of the foods, that is, which can realize high quality freezing by a simple arrangement.

Further, an object of the present invention is to obtain a refrigerator and a frozen food preservation method which can realize high quality freezing by a simple arrangement for performing cooling at a cooling temperature higher than a conventional cooling temperature without instantly freezing foods by ultra cold temperature air, which is commonly employed in a conventional freezing method, and can exhibit the merit of both energy saving and high quality freezing.

### Means for Solving the Problems

A refrigerator of the present invention has a freezing chamber or a cooling chamber, which is disposed in a refrigerator main body to accommodates therein foods such as fishes, meats, vegetables, fruits, and the like and is provided with temperature setting means capable of adjusting a temperature of cold air from a cooler to 0° C. to a temperature of a freezing temperature zone continuously or stepwise, a cold air adjustment means for circulating the cold air, which is blown off into the freezing chamber or the cooling chamber and sucked into the cooler, in the freezing chamber or the cooling chamber, and a controller for keeping the freezing chamber or the cooling chamber in a supercooled state, in which the food accommodated in the freezing chamber or the cooling chamber are not frozen even at a temperature equal to or less than a freezing point, by the temperature set by the temperature setting means and the direction and the amount of the cold air adjusted by the cold air adjustment means, wherein the controller performs an adjustment while lowering the temperature of the cold air within the temperature range from the freezing point to about −15° C. by the temperature setting means so that the food are kept in the supercooled state.

In a frozen food preservation method according to the present invention of a refrigerator, which comprises a freezing chamber or a cooling chamber for keeping an accommodated food in a supercooled state, in which the food is not frozen at a temperature set from a freezing point to −15° C. by cold air from a cooler, and cold air adjustment means for changing the temperature of the cold air blown off into the freezing chamber or the cooling chamber and circulating in the freezing chamber or the cooling chamber, the frozen food preservation method includes a step of accommodating the food in the freezing chamber or the cooling chamber set to −15° C. or more, a step of performing adjustment by cold air adjustment means so that the temperature in the freezing chamber or in the cooling chamber is set from −5° C. to −10° C. or the air velocity in the freezing chamber or in the cooling chamber is set to 0.5 m/s or less, and a step of stopping the supercooled state of the food, which is accommodated in the freezing chamber or the cooling chamber and placed in the supercooled state, by directly supplying cold air whose temperature is lower than the set temperature to the food.

### ADVANTAGES OF THE INVENTION

Since the refrigerator of the present invention employs, as a high quality freezing function, the supercooled freezing function with a simple structure in place of the conventional quick freezing, it has an advantage in that high quality freezing can be realized by the amount of energy smaller than the conventional amount thereof, that it, energy-saved freezing can be realized as a countermeasure for improving the global environment. Further, since the refrigerator of the present invention employs the cooling structure, in which cold air is introduced into the space for creating a supercooled state and the cooling temperature can be changed to a plurality of temperatures, it has an advantage in that foods such as meat and the like can be supercool-frozen by the structure and the control of a refrigerator which are not greatly different from conventional ones.

The frozen food preservation method of the present invention can realize various business systems such as a system for delivering frozen foods of good quality to a destination by storing them in a refrigerator mounted on a vehicle while keeping them in a frozen state by a small amount of energy consumption while they are transported for a long period of time.

### BRIEF DESCRIPTION OF THE DRAWINGS

FIG. 1 is a graph showing a the fluctuation of temperature when water is frozen without performing supercooling (a) and by performing supercooling (b).

FIG. 2 is a view showing the states of a meat structure at the time when meat is frozen by ordinary quick freezing and supercooled freezing and the state of a meat structure at the time when meat that is frozen once is defrosted.

FIG. 3 is a side sectional view of a refrigerator in the embodiment of the present invention.

FIG. 4 is a side sectional view showing an air duct arrangement of a refrigerator in the embodiment of the present invention.

FIG. 5 is a side sectional view of the periphery of a switching chamber of the refrigerator in an embodiment 1 of the present invention.

FIG. 6 is a structure view of a supercooling case in the embodiment 1 of the present invention.

FIG. 7 is a structure view of another supercooling case in the embodiment 1 of the present invention.

FIG. 8 is a structure view of another supercooling case in the embodiment 1 of the present invention.

FIG. 9 is a timing chart showing an example of a supercool control of the refrigerator in the embodiment 1.

FIG. 10 is a flow chart showing an example of the supercool control of the refrigerator in the embodiment 1.

FIG. 11 is a side sectional view of the periphery of the switching chamber of the refrigerator in the embodiment 1.

FIG. 12 is a side sectional view of the periphery of the switching chamber of the refrigerator in the embodiment 1.

FIG. 13 is a side sectional view of the periphery of the switching chamber of the refrigerator in the embodiment 1.

FIG. 14 is an upper surface view of a duct of the ceiling surface of the switching chamber in the embodiment 1.

FIG. 15 is a structure view of the supercooling case in the embodiment 1.

FIG. 16 is side sectional view of the periphery of the switching chamber of the refrigerator in the embodiment 1.

FIG. 17 is a side sectional view of the periphery of the switching chamber of the refrigerator in the embodiment 1.

FIG. 18 is a structure view of the supercooling case in the embodiment 1.

FIG. 19 is a schematic view showing the flow of cold air to the supercooling case in the embodiment 1.

FIG. 20 is a timing chart showing an example of a supercool control of the refrigerator in the embodiment 1.

FIG. 21 is a flow chart showing an example of the supercool control of the refrigerator in the embodiment 1.

FIG. 22 is a sectional view where a separately-installed case with a lid is disposed in the switching chamber of the refrigerator of FIG. 3.

FIG. 23 is a view showing how the supercooling case is installed in the switching case.

FIG. 24 is a view showing the relation between a cooling speed and the size of ice crystals created in food.

FIG. 25 is a view showing a display panel of the refrigerator in the embodiment 1.

### REFERENCE NUMERALS

1 refrigerator, 2 fan, 3 cooler, 4 air duct, 5 liquid crystal operation panel, 6 refrigerating chamber feedback path, 7 vegetable chamber feedback path, 10 compressor, 16 controller, 41 switching chamber air duct, 41a partition wall, 42 switching chamber back surface upper side blowing port, 43 switching chamber ceiling surface blowing port, 44 switching chamber back surface lower side blowing port, 45 switching chamber bottom suction port, 46 damper, 50 switching chamber ceiling surface duct, 51 switching chamber ceiling surface duct hole, 60 switching chamber lid, 70 fan, 80 switching case, 81 supercooling case, 82 switching case bottom, 83 switching case, 84 supercooling case, 85 switching case, 86 supercooling case, 90 switching case back surface cutout, 91 switching case front surface slit, 95 surface temperature measuring device, 96 ceiling surface, 100 refrigerating chamber, 200 switching chamber, 201 switching case, 202 supercooling case, 300 freezing chamber, 301 freezing case, 400 vegetable chamber, 401 vegetable case, 500 ice making chamber.

### BEST MODE FOR CARRYING OUT THE INVENTION

### Embodiment 1

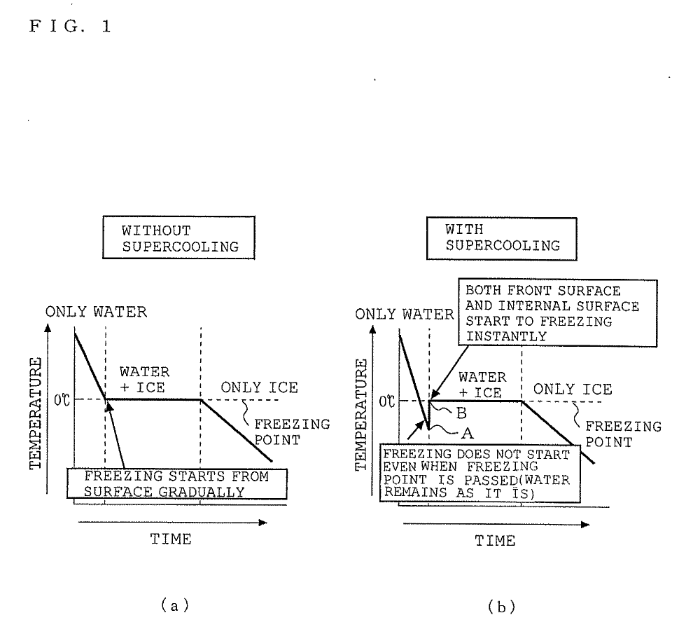

First, supercooling will be explained in detail. FIG. 1 is a graph showing a the fluctuation of temperature at the time when water is frozen without performing supercooling (a) and by performing supercooling (b). A longitudinal axis of the graph shows a temperature which increases in an upper direction of the graph. A lateral axis of the graph shows a time which shows a passed time in an arrow direction. A supercooled state is a state in which a substance is not frozen at all even at a temperature equal to or less than the freezing point thereof. The freezing point is a temperature at which the substance begins to freeze. That is, the supercooled state means that although a temperature, at which a substance begins to be frozen, is reached, it is not frozen at all. The freezing point of water is, for example, 0° C. The freezing point differs depending on substances, and the freezing point tends to become lower than 0° C. in foods and the like having a high salt concentration and a high sugar content. The supercooled state and a freezing point after passing through the supercooled state will be explained in more detail as to water as an example. The supercooled state is the state of water in which when water is cooled to a temperature less than 0° C. which is the freezing point thereof, the water is completely in the state of water.

Although the water, which enters the supercooled state, is frozen in a time and can be made to ice, a certain type of stimulation is required at the time. The necessary stimulation may be a temperature stimulation or a physical stimulation. As described above, although freezing can be started by stimulation, the time necessary to shift from the supercooled state to the start of freezing is an instantaneous time such as several seconds. However, the ratio of water which is instantly frozen at the time of start of freezing is only several percent of the entire water, and an additional cooling time is necessary to freeze 100% of the water.

Here, how ordinary freezing is different from supercooled freezing will be described here by comparing them with each other. First, the most outstanding difference between the ordinary freezing and the supercooled freezing is whether or not they enter a supercooled state. In the ordinary freezing, when a freezing point is passed, freezing starts without entering the supercooled state. Another large difference between the ordinary freezing and the supercooled freezing resides in the state at the time when freezing starts. What phenomenon occurs at the start of freezing will be explained using water contained in a PET bottle as an example. In the ordinary freezing, when freezing starts, the water in the vicinity of the surface of the PET bottle begins to freeze first, thin ice is formed on the surface portion of the PET bottle, and thereafter ice expands toward the inside of the bottle, and finally the entire water is frozen.

Ice is grown around an ice nucleus in which water molecules forms a cluster having at least a predetermined size, and the ice nucleus is formed when the freezing starts. Accordingly, in the ordinary freezing, it can be said that almost all the ice nucleuses are formed on the surface of the PET bottle and ice is grown therefrom toward the portion in the water state. In contrast, in the supercooled freezing, when freezing starts, ice nucleuses are evenly formed in the entire PET bottle. Since ice is grown to all the portions of the PET bottle including the inside and the surface thereof, it is not grown toward a predetermined direction.

The difference between the ordinary freezing and the supercooled freezing after the completion of freezing resides in that, in the ordinary freezing, large needle-like ice crystals are created from the surface toward the inside whereas, in the supercooled freezing, small granular ice crystals are uniformly created on the surface and the inside thereof, due to the difference of the cooling process. Further, the states at the time when freezing starts and after the freezing is finished in the quick freezing are the same as those in the ordinary freezing in that freezing is quickly performed by applying cold air onto the surface. First, since the temperature of the surface is lowered abruptly, freezing starts from the surface. However, the quick freezing is different from the ordinary freezing in that since a speed at which cooling is performed up to the inside is increased, ice nucleuses are liable to be created also in the inside as compared with the ordinary freezing, and thus ice crystals as large as those in the ordinary freezing are not created.

When freezing of food is examined, the quality of food at the time when it is defrosted is greatly affected by the size and the shape of ice crystals after the completion of freezing. Since almost all the foods are composed of cells, protein, carbohydrate, and the like, when the structure of the foods is broken once by ice crystals, it cannot be restored at all in many cases. Accordingly, it can be said that when ice crystals created in freezing have a size and a shape which do not break the intrinsic structure of food, good quality freezing can be performed.

When the state of crystals obtained by freezing agarose gel in a cooling chamber by ultra low temperature freezing set to −60° C. and the state of crystals obtained by freezing agarose gel in a cooling chamber by freezing passed through a supercooled state set to −18° C. are compared, the former crystals are greatly grown in a needle-shape, whereas the latter crystals spread entirely uniformly in a granular and fine state. When the above difference occurs at the time when food is frozen, the intrinsic structure of the food is broken by the former crystals whereas the food is not almost affected by the latter ice crystals, and thus frozen food having good quality can be obtained when the food is frozen through the supercooled state.

Next, a merit and a novelty obtained by freezing food by the supercooled freezing will be described. The maximum merit resulting from freezing food by the supercooled freezing resides in that good quality freezing can be performed. As described above, in the freezing through the supercooled state, since the inside of food is also sufficient cooled in a process in which the food is placed in the supercooled state, ice nucleuses are uniformly formed in the food in its entirety, and thus the ice nucleuses grow to small granular ice crystals. Further, when the difference between the lowest temperature, which is reached in the supercooled state, and the freezing point (the difference between a point A and a point B of FIG. 1(b)) is larger, a larger number of ice nucleuses are formed at the time when freezing starts, thereby finer ice crystals can be created. Accordingly, when supercooling occurs sufficiently (when the temperature at which the supercooled state is reached is as lower as possible), it is possible to keep a state nearer to the state before freezing even after the freezing and defrosting are performed.

When cooling of food and the size and the shape of ice crystals are examined, a period of time, during which food passes through a temperature zone set to −1° C. to −5° C. as a maximum ice crystal making zone, is conventionally taken into consideration. This is a way of thinking that when food is caused to pass through the maximum ice crystal making zone in a short time, ice crystals are made small in size. In the supercooled freezing, food stays in the nearby temperature zone (in the vicinity of about −1° C. to −10° C.) including the maximum ice crystal making zone for a long time in the supercooled state. However, the supercooled state is a state in which no freezing occurs. Accordingly, fine ice crystals can be created in the supercooled state without increasing the size of ice crystals after freezing even if a time necessary to pass through the temperature zone is long. This is a thoroughly novel freezing method in that small ice crystals are formed by the freezing performed in the nearby temperature zone including the maximum ice crystal temperature zone and that good quality freezing is performed.

Further, when the supercooled state is stopped, freezing begins, and food is completely frozen through a phase change state in which a temperature does not change. However, it is confirmed that when the food passes through the supercooled state, even if it stays in the maximum ice crystal making zone for a long time in the freezing process performed thereafter, ice crystals do not become enlarged. Accordingly, it can be said that this is a novel freezing method also in this point. When food passes through supercooling, even if a freezing process is performed for a long time thereafter, the state of ice crystal is hardly affected thereby. However, when the food is rapidly frozen at the time when it is put into a freezing process, a possibility that the ice crystals become enlarged is more reduced and further a factor of lowering food quality, other than ice crystals, can be also avoided. Thus, it can be said that better quality freezing can be performed.

Further, although only the merit obtained in the case when the food subjected to the supercooled state is released therefrom and frozen is described above, it is not always necessary to freeze the food subjected to the supercooled state. A merit for keeping the supercooled state resides in that the structure of food is not changed at all by ice crystals although the food is preserved at a low temperature. This is because the food is not frozen at all regardless that it is preserved at a temperature at which it were ordinarily frozen, that is, because ice crystals are not created at all.

Although it is ordinarily known that preserving food at a lower temperature is effective to keep freshness in that various chemical changes of food can be suppressed, it can be said that this preservation method can achieve both the merits of preserving food at low temperature and preventing food from being frozen. Further, it is not necessary to defrost food. However, it is also a demerit that food is kept in an unfrozen state. Since the water in food is not frozen, the water can be used to breeding of bacteria and various chemical changes. Accordingly, it is necessary to pay more attention to unfrozen food than to frozen food.

Next, the present invention will be explained in detail based on an embodiment thereof. A refrigerator according to the embodiment of the present invention includes a control mechanism for keeping a stable temperature environment which is necessary to stably realize supercooling, and for adjusting the temperature, the velocity, the amount, the timing, and the like of cold air directly blown to food, a structure of cases and the like for accommodating food, a device or a control mechanism for determining completion of supercooling which is necessary to securely stop the supercooled state, and a device or a control mechanism for applying stimulation necessary to stop the supercooled state.

Further, the refrigerator also includes a cooling and preserving function for keeping good quality freezing after stopping the supercooled state.

First, the supercooled freezing is divided into five states depending on the temperature of food:

(1) unfrozen state: a state in which the temperature of food is equal to or more than the freezing point thereof;

(2) supercooled state: a state in which the temperature of food is equal to or less than the freezing point of the food as well as the food is not frozen, that is, the supercooled state can be discriminated by that the temperature of the food is continuously reduced.

(3) supercooling stopped state: a state in which the temperature of food is returned to the freezing point from a temperature equal to or less than the freezing point;

(4) state from start of freezing to freezing completion: a state in which food reaches the freezing point, changes its phase (in a case of water, it changes from liquid water to solid ice), and keeps a constant temperature; and

(5) state of freezing completion and preservation of food in frozen state: a state in which food is frozen after it is subjected to the process of the item (4).

The freezing points of leading foods will be explained here. Beef/pork has a freezing point of −1.7° C., tuna has a freezing point of −1.3° C., potato has a freezing point of −1.7° C., strawberry has a freezing point of −1.2° C., and apple has a freezing point of −2.0° C. (reference document: Sougou Shokuhin Kogyo, p. 922 (1975)). The states shown in the items (1) to (2) are conditions necessary to subject food to supercooling (in which the temperature of food is brought to a temperature equal to or less than the freezing point thereof although the food is kept in an unfrozen state) and a condition for making the supercooling deeper (for lowering the temperature which is reached in the supercooled state), the state shown in the item (3) is a condition for stopping the supercooled state and starting freezing, and the states shown in the items (4) and (5) are conditions for keeping the goodness of the food subjected to the supercooled freezing.

When a sufficiently deep degree of supercooled state (a temperature difference between the freezing point of food and a temperature reached during supercooling) is obtained by controlling the states shown by the items (1) to (3), the effect of the supercooling is not lost by the states shown by the items (4) and (5). However, when the supercooled state is stopped by opening a door for a long time to charge or to take out food in a supercooled state, or by increasing a set temperature to a temperature equal to or more than the freezing point temperature so as to make the temperature in a supercooled chamber becomes, for example, 0° C. or more, the state in the refrigerator is restarted from the state (1). Next, the processes of the items (1) to (3) will be described.

First, a result of examination will be described based on a case in which that beef having a thickness of 15 mm and weight of 150 g is charged as food. The supercooling condition of the supercooled chamber (the same as a supercooling space) of the refrigerator of the present invention will be explained. A point to which an attention must be paid at the time of setting the supercooling condition is a cooling speed, the difference between the lowest reach point (temperature reached in the supercooled state) of the core temperature of food to be cooled and the freezing point, and the like. When the cooling speed is too fast, the food is cooled in the state that the overall temperature thereof is uneven (the difference between the surface temperature of the food and the core temperature thereof is large), a frozen portion and an unfrozen portion are formed in the food.

Since ice crystals are grown around ice nucleuses, even if a part of food is frozen, the ice crystals are grown while taking the water of the unfrozen portion from the partly frozen portion. As a result, large needle-shaped ice crystals are created. Needle-like ice crystals and large ice crystals created between cells and the like act as a cause for flowing out of water in the cells and breaking cells, and flowing out of a drip during defrosting food is caused. As a result, “flavor” intrinsic to the food is reduced, nutrient contents such as free amino acid and the like are reduced, and the texture is deteriorated. In contrast, in the case when the cooling speed is too slow, since an unfrozen state continues for a long time, a problem arises in that food quality is deteriorated by breeding bacteria, accelerating oxidation, and the like, although no problem is arisen to keep the supercooled state.

That is, the unfrozen state is prevented from being prolonged by stopping the supercooled state by performing cooling so that the difference between the surface temperature and the core temperature is reduced until the freezing point is reached, and increasing the cooling speed at the time when a temperature equal to or less than the freezing point is reached (when the supercooled state is achieved) so that the lowest reach point of the core temperature is reached quickly. As described above, the respective temperature controls and the respective cold air adjustments are performed continuously or stepwise until the food reaches the freezing point, the supercooled state equal to or less than the freezing point and completely frozen point after stopping the supercooled state, respectively. To solve the above problems, there is also a method of providing the supercooling space with an anti-bacteria function. A method of using ultraviolet rays or ozone is exemplified as the anti-bacteria function. However, provision of the anti-bacterial function is disadvantageous in that a cost is increased.

First, the cooling speed will be explained with respect to a condition for entering the supercooling. Food is cooled from the surface thereof, and the central portion thereof is cooled by heat conduction depending on the type and the thickness of the food. This is because the cooling speed of the central portion of the food is determined after the cooling speed of the surface thereof is determined. Further, when the fluctuation of temperature of food is actually controlled in a home refrigerator, since the surface temperature of the food is ordinarily detected. Therefore, the surface temperature is prescribed first. When the temperatures of the surface and the central portion of food change with time at the time the food is supercooled, these temperatures tend to be lowered approximately similarly. In a case of the beef having the thickness of 15 mm and the weight of 150 g, the temperature of air around the periphery of the beef reaches a set temperature, for example, −5° C., −7° C., and −10° C. in about 30 minutes, the timing at which the surface temperature of the food reaches a freezing point is more delayed by about 120 minutes, about 80 minutes or less, and about 60 minutes or less, respectively as the set temperature becomes higher.

The difference between the temperature of the central portion of the food and the temperature of the surface thereof is small and about 0.5° C. to 3.0° C., respectively. However, a higher temperature is set to air, the difference between the temperature of the surface and the temperature of the central portion is more reduced, and a lower temperature is set to air, a degree of supercooled state, that is, energy required in freezing is more reduced. The cooling speed is calculated in the range in which the surface temperature of the food falls to 3° C. to 0° C. The cooling speed in the temperature zone is a temperature zone relating to whether entering to cooling is possible or not. When the temperature set to the periphery of the food is −5° C., the cooling speed on the surface of the food is about 3.5° C./h, when the temperature set to the periphery of food is −7° C., the cooling speed on the surface of the food is about 5.5° C./h, and when the temperature set to the periphery of food is −10° C. and the supercooling is shallow, the cooling speed is about 10° C./h.

As a result, it is shown that when the surface of food is apart from the central portion thereof, the cooling speed of the surface of the food is 10° C./h or less and preferably 5° C./h or less as the condition for entering the supercooling. Further, at the time, there is also a temperature difference between the surface of the food and the central portion thereof. When the set temperature is −5° C., the temperature difference between the surface of the food and the central portion thereof is about 1° C. (K) (the cooling speed is about 3.5° C./h at the central portion of the food), and when the set temperature is −7° C., the temperature difference between the surface of the food and the central portion thereof is about 2° C. (K) (the cooling speed is about 5° C./h at the central portion of the food).

In contrast, when the set temperature is −10° C. at which the supercooling is shallow, the temperature difference between the surface of the food and the central portion thereof is about 3° C. (K) (the cooling speed is about 10° C./h at the central portion of the food). It is shown from the above result that the temperature difference between the surface of food and the central portion thereof is 3° C. (K) or less and preferably 2° C. (K) or less as the condition for entering the supercooling. When the distance between the surface of the food and the central portion thereof is small, that is, when the heat capacity of the food is small, for example, in the case of thin meat and the like, the degree of supercooled state is not made shallow even if the set temperature is below −10° C., for example, −15° C. Then, a good frozen food can be obtained.

It can be contemplated from what has been described above that the cooling speed of the surface of food is the cooling speed at which the temperature difference between the surface of food and the central portion thereof becomes 3K or less as a condition. It is contemplated that the following phenomena can be avoided: a) when a temperature difference is increased between the surface of food and the central portion thereof, the density of the water contained in the food changes, and the convection of the water contained in the food is caused by the difference between densities of the water. Accordingly, since the association rate of water molecules is increased to stimulate formation of ice nucleuses enough to grow into crystales, the supercooling is liable to be stopped: b) when the surface of the food is frozen first, a stable environment is formed to the food in its entirety in the state that the surface of the food is set to a constant freezing point temperature. Accordingly, the food is stably kept at the freezing point, and all the cooling heat transmitted from the surface of the food is used as latent heat, thereby freezing is proceeded. Therefore, when the surface of the food is frozen, the food is not entirely supercooled.

In contrast, as to the air temperature around the periphery of food, it is ordinarily preferable to set the air temperature around the periphery of the food to −10° C. or more to bring the temperature of the food to the freezing point thereof or less while keeping it in an unfrozen state, although the temperature is different depending on the type and the thickness of the food. It is apparent that the upper limit of the air temperature around the periphery of food is equal to or less than the freezing point of the food which is desired to be supercooled. The upper limit temperature of, for example, beef and pork is −1.7° C. or less, and the upper limit temperature is set to −2° C. to almost all the foods. The cooling speed for suppressing the temperature difference to 3° C. (K) or less is about 3.5° C./h to about 10° C./h and particularly preferably about 5° C./h or less.

However, when a food has a thickness of 10 mm or less as in a sliced meat and the like, the supercooled state is entered by setting the cooling speed to 300° C./h or less, and the cooling speed of about 2° C. to −3° C./h is necessary for a block meat having a thickness of about 40 mm to 50 mm. It is sufficient in any food to suppress the temperature difference between the surface of the food and the central portion thereof to about 3° C., for any food. Although a homogeneous food material such as yoghurt, which is in a gel state, and in which water is liable to be held at a predetermined position, and which is liable to be supercooled, is supercooled at the cooling speed of about 3.5° C./h to about 10° C./h, it is also supercooled at the temperature set to −18° C. and in the temperature difference of 5° C. to 10° C.

To cope with the temperature unevenness around the periphery of food as one disurbing factor at the time when the supercooled state is entered and the supercooled state is kept, it is sufficient to suppress an even cooling speed, that is, to reduce the cooling speed around the periphery of the food. Further, it cannot be avoided that the air temperature in the periphery of the food is fluctuated by the influence of the operation of various equipment such as turning on and off of a compressor, turning on and off of a fan in the refrigerator, opening and closing of a damper, and the like for causing the refrigerator to control an air temperature to a certain predetermined temperature. When the air temperature is fluctuated, the temperature fluctuation in the food is increased. Accordingly, the convection of water in the food is accelerated. That is, since the association rate of water molecules is increased, the supercooled state is liable to be stopped. To avoid the convection to enter into the supercooled state, the range of temperature fluctuation to exceed the freezing point (for example, −1.7° C.) of food, that is, the range of temperature fluctuation until entering into the supercooled state was within about 6° C. (K) or less in an experiment.

Stimulation for stopping the supercooled state must not be applied to the surface of food regardless of the size and the type of food. Accordingly, it is preferable that the fluctuation of the air temperature around the periphery of food be within 6K as described above. However, it is possible to create the supercooled state even if the degree of supercooled state is made shallower or the probability at which the supercooled state is realized is reduced somewhat. The supercooled state can be entered even in the environment, in which the temperature fluctuation is larger than 6K, for example 15K in the vicinity of a blowing port, and the supercooled state can be made deeper even for a food material which is liable to be supercooled. It is not necessary to perform cooling at the same temperature to enter into the supercooled state and to make it deeper.

When food is cooled at a predetermined temperature, it is cooled, the surface temperature of the food is lowered, and the temperature difference between the surface temperature of the food and the air temperature around the periphery of the food is reduce, thereby the surface temperature of the food is approximately stabilized at the air temperature around the periphery of the food. Accordingly, to make the supercooled state deeper, it is preferable to perform cooling (deepening) while keeping the temperature difference between the air temperature on the surface of the food and that around the periphery of the food. For this purpose, it is preferable to lower the air temperature around the periphery of the food according to the temperature of the surface of the food or the temperature of the central portion thereof. In a process for making the supercooled state in a home refrigerator deeper, a set temperature may be lowered by 1° C. at each predetermined time (this is a time previously examined in an experiment at which the temperature of the food is lowered by 1° C.; for example, 0.5 hour) after a predetermined period of time passes (this is a period of time previously examined in an experiment during which the temperature of the central portion of the food reaches to −1° C. after it is charged; for example, 2 hours.

With this operation, since the food can be cooled while keeping the temperature difference between the air temperature of the surface of the food and that around the periphery thereof, the supercooled state can be made deeper. Conversely, when the air temperature has a large amount of unevenness or when the air temperature is greatly fluctuated, since the temperature of the surface of the food is distributed in a large range or the surface of the food has a large heat transmission rate. Thus, crystallization begins from the portion of the surface which is liable to be cooled and thus the supercooled state is stopped.

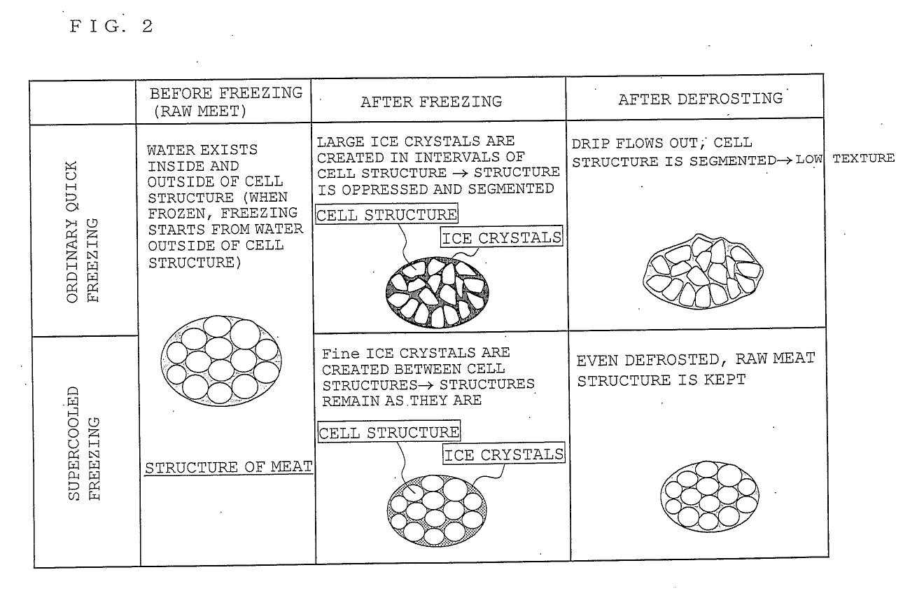

FIG. 2 is a view showing the states of meat structure at the time when a meat is frozen by an ordinary quick freezing, and a supercooled freezing, and when a meat frozen once is defrosted. As shown in the figure, it is known that when ice crystals, which are created in meat, fish, and the like during freezing them, has a large size, cells are broken and an amount of drip is increased after they are defrosted. When the amounts of drip of beef round and tuna which are subjected to the supercooled freezing and to ordinary freezing are compared with each other, there is found a tendency that the amount of drip of the beef round and tuna subjected to the supercooled freezing is suppressed to half the amount of drip of those subjected to the ordinary freezing. It is assumed that root and tuber crops such as potato and the like are not suitable for conventional freezing. When curry and the like are made, it is reserved in a frozen state and eaten after it is heated again in the next day or later ordinarily in home. At the time, it is a common sense to freeze the curry after only the potatoes are removed or crushed in order to freeze the curry tastefully. This is because when the potatoes are defrosted after they are frozen, they are made coarse and the texture thereof is deteriorated.

However, when the curry is frozen by the supercooled freezing, the texture of the potatoes is not almost different from that before freezing them, and the coarse or mushy texture of the potatoes can be eliminated. Starch as a main component of potato is composed of amylose and amylopectin. The three-dimensional structure of them are broken by the growth of ice crystals in the conventional freezing methods, and since the structure broken once is not restored even if the potato is defrosted, thereby the potato is made coarse. In contrast, it is contemplated that since the ice crystals made by the supercooled freezing are very fine, they do not almost deform the three-dimensional structure of starch during freezing and thus the original three-dimensional structure can be kept.

Accordingly, it is contemplated that the texture of the potatoes, which are defrosted after they are subjected to the supercooled freezing, is not deteriorated. This principle may be applied to the other foods which are assumed to be not suitable for freezing, and thus it is suggested that the foods which are conventionally assumed to be not suitable for freezing can be frozen when the supercooled freezing is used. As described above, it is found that when food and the like are frozen through the cooled state, fine ice crystals are created, so that the intrinsic food structure of cells, protein, and the like can be kept without being changed.

Accordingly, even if freezing and defrosting are repeated such as when food, which is frozen and defrosted once, is frozen again and the like, there is a possibility that the quality of the food is not extremely deteriorated differently from the conventional freezing. Although the merits obtained by using the supercooled freezing in ordinary home, is described above, it can be said that the supercooled freezing can be effectively utilized when foods are processed. There is obtained a result that the fineness of ice crystals created by the supercooled freezing is superior to those obtained by freezing performed at −60° C., and thus it can be said that the supercooled freezing can be substituted for a business-use freezing chamber in that high quality freezing can be realized. Since it is not necessary to create ultra cold temperature using a large amount of energy as in the business-use freezing chamber, there is a merit of great energy saving.

It is assumed in the above examination that the velocity of the cold air flowing around the periphery of food is 0.5 m/s. The cooling speed of food is determined by the temperature difference between the air temperature of the surface of the food and that around the periphery thereof and a convection heat transmission rate. This is because that a smaller convection heat transmission rate can more reduce the temperature difference between the temperature of the surface of the food and the temperature of the central portion thereof and that it is desired to make a supercooled state quickly. Note that the cooling speed is prescribed by the variation per hour of the surface temperature of the food, and a thermopile is exemplified as a means for detecting the surface temperature of food in an actual product. The thermopile detects the surface temperature of food in a non-contact manner by receiving the radiation heat generated by infrared rays emitted from the surface of the food. With this operation, the control time in each process can be extended or shortened according to a charged food by presuming the temperature and the area of the food from the temperature detected by thermopile at the time when the food is charged into a switching chamber and the like of the refrigerator and further presuming the heat capacity of the charged food from the variation per hour of the temperature detected by thermopile thereafter.

Since the supercooled state is originally an unstable state, it is stopped at the time when a certain type of stimulation is applied thereto. In general, it is said that the supercooled state is stopped by vibration. However, when, for example, a sealed vessel is filled with water without a space, and the like, the supercooled state is not stopped even if, for example, the vessel is shaken violently, and further it is not stopped even if the water is charged into a pull-out type chamber of a refrigerator, for example, a switching chamber and the door thereof is completely opened and closed several tens of times. However, when only one half of the sealed vessel is filled with water, the supercooled state is stopped at once. From the fact mentioned above, it is contemplated that a space, in which a liquid is free to flow, is necessary to stop the supercooled state by vibration.

In the foods such as meats, fishes, fruits, and the like, since the respective cells thereof and the portions between the cells thereof are filled with water without a space, they correspond to a sealed vessel filled with water without a space. Actually, the supercooled state is not stopped in the switching chamber in which a supercooled meat is charged even if the door thereof is completely open and closed repeatedly. Further, the percentage of the entire food in which ice nucleuses are formed at the time of stopping the supercooled state is determined by the degree of the supercooled state. When, for example, the degree of supercooled state is 4° C. (K), it is apparent from the following expression of a freezing ratio that ice nucleuses are formed by the five percentage of the water contained in the entire food.

freezing ratio (%)=(Cp*rv*ΔT)/L*rv*100
Cp; specific heat (kJ/kgK)
r; density (kg/m³)
V; volume (m³)
L; latent heat (kJ/kg)
ΔT; temperature difference (K)

When the degree of supercooled state is 4° C., ice crystals are formed in a fine granular shape. Food reaches to the freezing point, causes a phase change (in the case of water, it changes from water of a liquid to a solid ice) and becomes kept at a constant temperature during the period of time from the time at which the temperature of the food is returned to the freezing point from a temperature equal to or less than the freezing point after stopping the supercooled state (the temperature difference at the time is the degree of the supercooled state) to the time at which the food begins to be frozen and is placed in a completely frozen state in a next process. Thereafter, the freezing is completed, and the food is placed in a frozen preservation state at the set temperature. When only the supercooled state is caused, a subsequent freezing speed does not affect an ice crystal shape, fine ice nucleuses are formed in the supercooled state, and the ice crystals of the entire food are made fine, provided that the ice nucleuses are distributed to the entire food.

As described above, it is possible to determine the percentage of the water contained in the entire food, where the ice nucleuses are formed during stopping the supercooled state, on the basis of freezing ratio. According to the data of an experiment, when the degree of supercooled state is 0.8° C., the freezing ratio is about 1% and ice crystals are formed in a large needle-shape. When the degree of supercooled state is increased up to 2.6° C., ice crystals are made considerably fine. However, when the freezing ratio is about 3% and the degree of supercooled state is increased to 4.1° C., ice crystals are made so fine that they cannot be discriminated by naked eyes, and the freezing ratio at the time is about 5%.

As described above, ice nucleuses are uniformly created to the entire food regardless that the ice nucleuses which are created during stopping the supercooled state occupy only several percentages of the water contained in the entire food, on which the state of the ice crystals depend during the freeze preservation performed thereafter. Further, the energy accumulated in the supercooled state is used as energy when ice nucleuses are created. Accordingly, it is contemplated that a higher degree of supercooled state and a larger amount of accumulated energy create a larger amount of ice nucleuses during stopping the supercooled state and the diameter of ice crystals is reduced thereby and that food is less damaged by the ice crystals.

As described above, it is necessary to cool food accommodated in the refrigerator by a certain range of cooling capability in order to place the food in the supercooled state. This means that the supercooled state cannot be achieved or the supercooled state is stopped at once when the cooling capability for cooling food is too weak or too strong. When the cooling capability is weak, although the accommodated food is liable to be placed in the supercooled state, the cooling capability around the periphery of the food is weak, that is, a temperature becomes high, and thus the reach temperature point of the food in the supercooled state is also increased with a result that the supercooled state is not made deeper (a temperature is more lowered) and stopped. In general, since a larger amount of energy is generated by a deeper supercooled state, fine crystals are created in the food and high quality freezing is performed, and thus a deeper supercooled state cannot be established only by a weak cooling capability.

As to the depth of the supercooling, when the depth becomes at least 3K (when, for example, the temperature of food reaches to −4° C. in the supercooled state, and then the temperature is instantly increased to −1° C. by stopping the supercooled state), a large difference is caused in the amount of drip flow during defrosting meat. Therefore, it is necessary to forcibly create a deeper supercooled state. On the contrary, when the cooling capability is too strong, a phenomenon arises in that when the temperature of food reaches to the freezing temperature thereof, it is frozen as it is and that even if the supercooled state is entered, it is stopped at once by being stimulated by the strong cooling capability. As a result, a deep degree of supercooled state cannot be obtained, and thus it is a necessary condition to cool food by a cooling capability within a certain range.

As described above, when food is charged into the refrigerator at the time when the cooling capability is weak (that is, when a chamber temperature is high), the chamber temperature transit at about −3° C. to about −4° C. Accordingly, even if the food is cooled at the temperature, the temperature of the food cannot be naturally made lower than the chamber temperature which is set to −3° C. to −4° C. Accordingly, since a deep supercooled state cannot be obtained, the room temperature is lowered little by little. However, the supercooled state is eventually stopped when the food temperature becomes about −3° C. As described above, when the cooling capability is weak (that is, when the chamber temperature is high), although the supercooled state is entered, it cannot be entered deeply, so that a user less feel a meaningful difference as a food. Further, when the cooling capability is strong (that is, when the chamber temperature is low), the supercooled state is not entered and freezing is started when the freezing temperature is reached.

However, in a case that the air temperature is set to −10° C. or more, although the chamber temperature can be lowered only to the level of about −7° C. to −8° C., it is sufficiently possible to obtain at least 3K as the depth of the supercooled state. Further, when the set temperature is lowered, a deeper supercooled state can be achieved by lowering the temperature from the vicinity of the freezing temperature of food (about −1° C.). Further, when the temperature is reduced, it is preferable to lower the temperature gradually so that a strong stimulation is not applied to the food. Even if the supercooled state is stopped by lowering the set temperature by, for example, 2° C., the supercooled state is not stopped the set temperature is lowered by 1° C. because stimulation caused by a temperature gradient at the time is relaxed.

Subsequently, as described already, there is the distribution (unevenness) of an air temperature in the vicinity of the food to be subjected to the supercooled state as another necessary condition of the supercooled state. This is because such a phenomenon is caused in that unless food is placed within a certain range of the distribution (unevenness) of the air temperature, the supercooled state is not entered or is stopped at once. This is because freezing is started from a portion of food having a low temperature in the uneven temperatures of the food or the supercooled state is stopped therefrom with a result that the freezing is performed or the supercooled state is stopped so that the influence thereof reaches to the portion of the food having a high temperature.

Accordingly, it is the necessary condition to perform cooling within the certain range of the temperature distribution (unevenness). Specifically, it is preferable that the uneven air temperature be as small as possible. However, since refrigerators are differently made and accommodated foods have various sizes and shapes, it is preferable to set the uneven temperature to about 2K or less. When an uneven temperature and the depth of supercooled state are statistically examined by an experiment regardless of a room temperature, it is found that when the uneven temperature is set to 2 k or less, the probability of realizing the supercooled state can be increased. It is possible to set the probability ratio of realizing the supercooled state can be made very near to 100% by multiplying the necessary condition by the set temperature described above.

The temperature is kept constant by turning on and off the compressor mounted in the refrigerator to adjust a cooling intensity and using a damper adjusted by temperature sensors disposed to the respective chambers. Accordingly, there inevitably exists a time during which cold air is supplied and a time during which no cold air is supplied (cold air is turned on and off) in the respective chambers of the refrigerator. Therefore, in order to adjust the temperature set to a chamber, cold air whose temperature is lower than the temperature of the chamber must be supplied. However, in order to realize the supercooled state, food must be placed in the supercooled state at the temperature described above.

In this case, it is desired to continuously perform cooling at a temperature of −15° C. or more and preferably at a temperature of −10° C. or more which is the necessary condition of the air temperature nearer to the food. However, since it is actually difficult to realize an atmosphere without temperature hunting in a home refrigerator, the temperature of cold air supplied to the vicinity of the food to be supercooled is controlled. Means for realizing the above control is largely classified to two means. A first means is a means for making the temperature of the cold air for cooling the chamber near to an optimum supercooling temperature. Ordinarily, when a chamber whose temperature can be set within the freezing temperature zone in the refrigerator is cooled, the temperature of the cold air for cooling the chamber reaches to the level of about −25° C. at the supply port (blowing port) of the cold air. Since the temperature has a value which is considerably apart from the optimum supercooling temperature, it is an effective means to control the temperature of the source from which the necessary cold air is supplied.

Exemplified as a first means is a means for increasing the temperature of the cold air by reducing the freezing capability of the compressor. However, since the intrinsic cooling capability exceeding the supercooled state must be secured, the temperature of the cold air to be supplied is increased by reducing the number of revolutions of the compressor by controlling an inverter and the like in place of reducing the capability of the compressor itself. Actually, it can estimated that a blowing-out temperature is increased about 3K to 5K when the number of revolutions of the compressor is reduced to the level of 10 rps.

Further, it is also possible to control the temperature of the cold air to be supplied by changing the number of revolutions of the blowing fan in the refrigerator for supplying the cold air. Actually, when the number of revolutions of the fan is reduced, since the speed of the cold air is reduced, transmission of convection heat is suppressed and thus the temperature of the cold air is also lowered. Accordingly, when the number of revolutions of the fan is increased inversely, heat exchange is accelerated and a cold air supply temperature is increased. Actually, it can be estimated that when the number of revolutions of the fan in the refrigerator is increased by 300 rpm to 400 rpm, the temperature of the cold air is increased by about 2K to about 3K. In addition to the above-mentioned, it can be contemplated to increase the temperature of the cold air by disposing a heat insulation heater and the like to the vicinity of a blowing port for supplying the cold air.

A second means is a means for increasing the temperature of the cold air before it is impinged against the food in place of increasing the temperature of the cold air to be supplied so that the cold air having a low temperature is not directly impinged against the vicinity of the food as far as possible. Increasing a cold air reach distance from a cold air supply port to the food is exemplified to realize the above means. The means can be realized by a structure in which a cold air rectifying guide is disposed around the periphery of the cold air supply port, or an obstacle is disposed between the blowing port and the position at which the food is disposed. With this arrangement, the temperature of the cold air reaching to the periphery of the food can be increased by the heat exchange performed in the midway.

Further, since the blowing speed of the cold air blown against the food can be also reduced, the food can be gradually cooled without giving a strong stimulation. As an example of disposing the obstacle between the blowing port and the position at which the food is disposed, it is possible to provide a lid shape above a food accommodation case. The distance from the cold air blowing port on the back surface side of the refrigerator to the opening of the case disposed to the door side thereof can be made longer than half the length of the case by the lid. When the airflow in this case is analyzed, it is possible to increase the temperature of the cold air in the vicinity of the food and further to reduce an air velocity by adding the lid shape.

Further, a damper for controlling the cold air to be supplied is located between the blowing fan for circulating the cold air in the refrigerator and the blowing port, and the damper acts as a shutter for supplying the cold air by reducing the amount of cold air by adjusting the angle thereof. The damper can adjust its opening angle to any angle, in addition to a totally closed state and totally open state so that the air velocity of the cold air to be blown to the food can be suppressed by reducing the amount of cold air. The air velocity at the cold air blowing port is set to 1.0 m/s to 1.2 m/s by adjusting the degree of opening of the damper, a lid is disposed to the case so that the cold air is supplied from the door side into the case, and the air velocity in the case is set to 0.1 m/s to 0.5 m/s to keep the supercooled state. Although the first means and the second means may be performed individually, it is also possible to set the temperature in the vicinity of the food to a temperature convenient to the supercooled state by performing the first and second means in combination.

Further, the means for improving an uneven temperature is a means for suppressing the uneven temperature and hunting by reducing the number of times in which cold air supply is turned on and off. As described above, in this means, the number of revolutions of the compressor is reduced by the controller to supply a cold air having a higher temperature, and the number of times in which the cold air supply is turned on and off, is reduced by increasing a time necessary to reach a set temperature, so that the uneven temperature and hunting are improved. As described above, since a cooling capability can be reduced by the above means for reducing the number of times, in which the cold air supply is turned on and off, this means is also effective likewise the reduction of the amount of cold air performed by adjusting the angle of the damper described above.

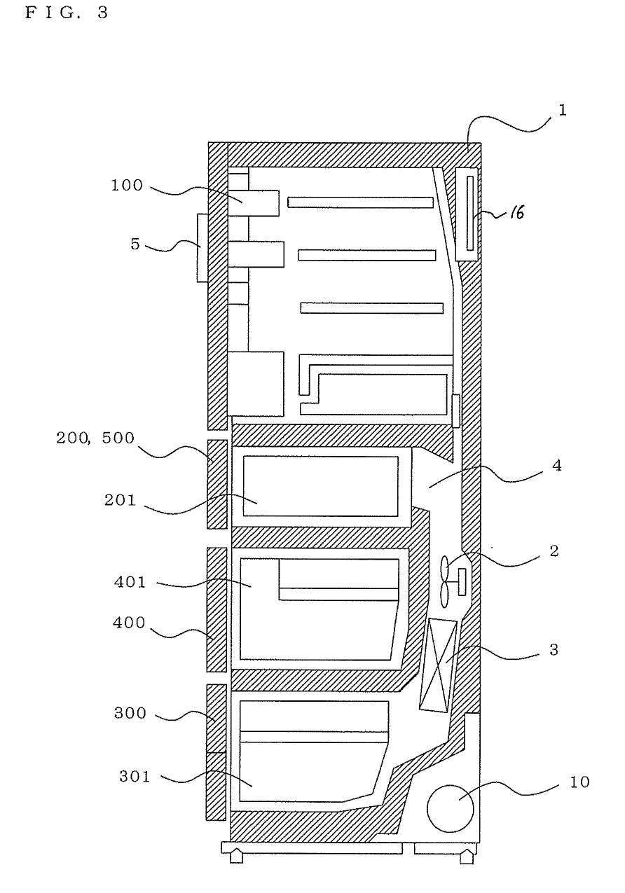

Next, a structure of a supercooling space for realizing the supercooled state, a method of determining the timing at which the supercooled state is stopped, and a method of stopping the supercooled state will be explained referring to the drawings. Note that it is assumed in the following drawings that the same reference numerals denote the same components or corresponding components. A refrigerator in the embodiment 1 of the present invention in which a freeze preservation is performed through the supercooled state will be explained in detail. FIG. 3 is a sectional view of the refrigerator 1 in the embodiment 1 of the present invention.

A food storage chamber of the refrigerator 1 is composed of a refrigerating chamber 100, which is disposed in an uppermost portion thereof and has an opening/closing door, a switching chamber 200, which is disposed to a lower portion of the refrigerating chamber 100 and has a pull-out door, capable of being switched from a freezing temperature zone (−18° C.) to temperature zones such as a refrigerating zone, a vegetable zone, a child zone, a soft freezing zone (−7° C.), and the like, an ice making chamber 500, which is disposed in parallel with the switching chamber 200 and has a pull-out door, a freezing chamber 300, which is disposed to a lowermost portion of the refrigerator and has a pull-out door, a vegetable chamber 400, which is located between the freezing chamber 300, and the switching chamber 200 and the ice making chamber 500 and has a pull-out door, and the like. An operation panel 5 is disposed on the front surface of the door of the refrigerating chamber 100. The operation panel 5 is composed of operation switches for adjusting the temperatures set to the respective chambers, liquid crystal displays for displaying the temperatures of the respective chambers at the time, and the like. A controller 16 is disposed on the back surface side of the refrigerating chamber 100. The controller 16 is controlled by the operation panel and controls a compressor and the opening and closing of a damper to adjust the temperatures detected by temperature detectors disposed to the respective chambers to set temperatures.

The compressor 10 and a cooler 3, which constitute a freezing cycle, are disposed on the back surface side of the refrigerator 1, and further a fan 2 and an air duct 4 are disposed. The fan 2 supplies the cold air cooled by the cooler 3 to the refrigerating chamber 100 and the switching chamber 200, and the air duct 4 introduces the cold air cooled by the cooler 3 into the refrigerating chamber 100. Further, the compressor 10, the fan 2, and the like are controlled by the software stored in a microcomputer attached to a control substrate of the controller 16 disposed in the exterior of the refrigerator 1 in the upper portion of the back surface thereof, based on the signals detected by the temperature sensors disposed in the chambers together with the control operation, the display, and the like of the operation switches and the operation panel 5. Note that an accommodation case 201 is disposed in the switching chamber 200, an accommodation case 301 is disposed in the freezing chamber 300, an accommodation case 401 is disposed in the vegetable chamber 400, respectively, and foods can be accommodated in these cases.

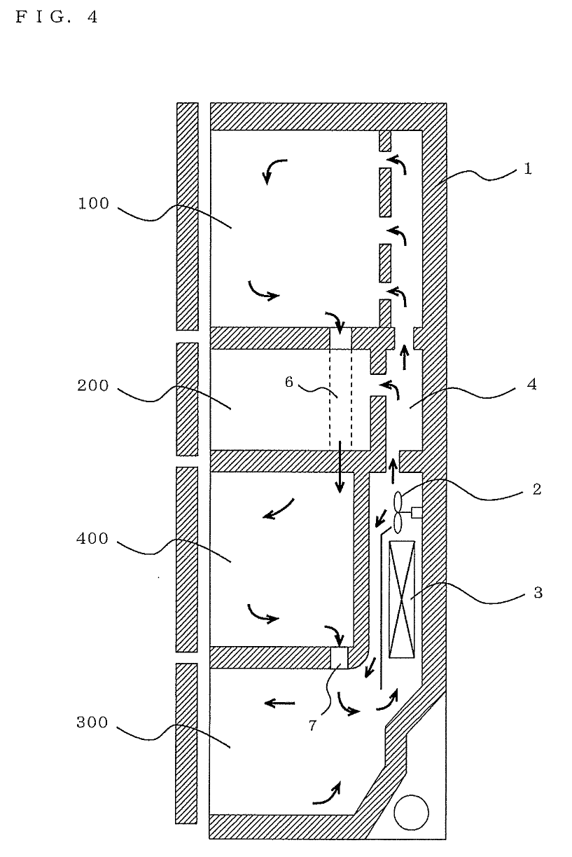

FIG. 4 is a schematic side sectional view of the refrigerator showing the air duct arrangement of the refrigerator in the embodiment 1 of the present invention. A part of the cold air cooled by the cooler 3 is supplied to the freezing chamber 300. Further, the remaining cold air is supplied to the switching chamber 200 passing through the air duct 4. A part of the cold air passing through the air duct 4 is further supplied to the refrigerating chamber 100 on an upper stage and cools it. The vegetable chamber 400 is cooled by the cold air returned from the refrigerating chamber 100 and circulated by a refrigerating chamber feedback path 6, and the air passing through the vegetable chamber 400 is returned to the cooler 3 through a vegetable chamber feedback path 7.

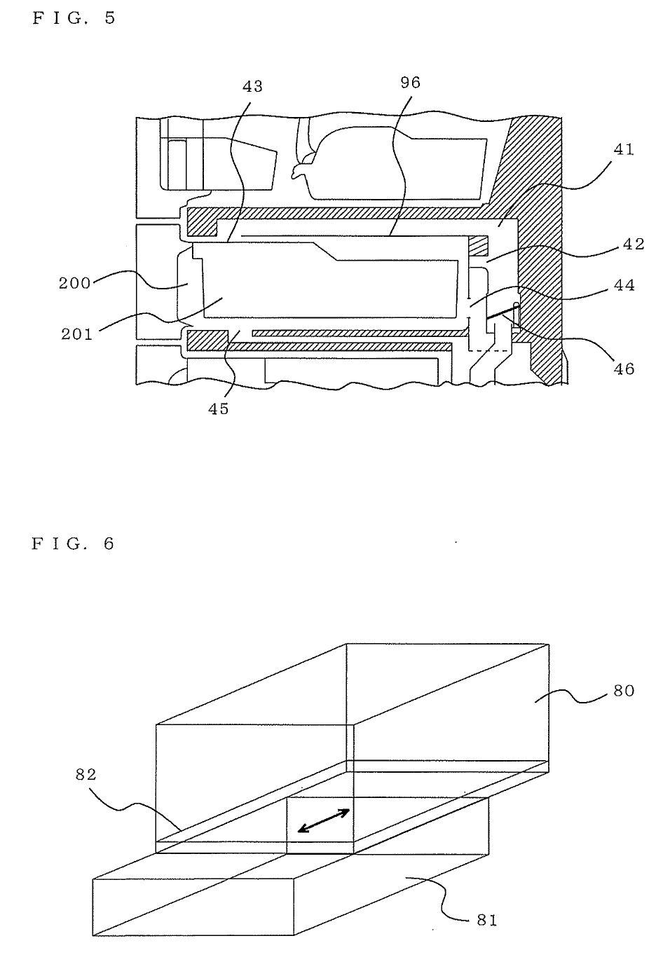

FIG. 5 is a side sectional view of the switching chamber 200 in the embodiment 1 of the present invention. The switching chamber 200, which is located between the refrigerating chamber 100 and the vegetable chamber 400, is provided with a switching chamber air duct 41 for introducing the cold air from the air duct 4 to the switching chamber 200 through a damper (switching chamber damper) 46. A switching chamber back surface upper side blowing port 42 is disposed to a left upper portion of the back surface of the refrigerator when viewed from the front surface thereof and a switching chamber ceiling surface blowing port 43 is disposed to the front end side of a ceiling surface. They act as cold air flowing ports.

Further, a switching chamber back surface suction port 44 is disposed to a right under portion of back surface of the switching chamber 200, and a switching chamber bottom suction port 45 is disposed to the bottom thereof. The switching chamber 200 can be switched to six types of temperature zones, that is, to a refrigerating zone (about 3° C.), a chilled zone (about 0° C.), a soft freezing zone (about −5° C., −7° C., −9° C.)), a freezing zone (about −17° C.), and the like. The temperatures can be switched by a liquid crystal panel 5 disposed to the door of the refrigerating chamber 100. The temperature of the switching chamber 200 is controlled by the temperature set to a not shown thermistor and the value detected by thermistor.

Next, a structure for installing a supercooled chamber in the switching chamber 200 will be explained. FIG. 6 is a structure view of a supercooling case in the embodiment 1 of the present invention. In FIG. 6, the switching chamber accommodation case 201 shown in FIG. 5 is arranged as a two-stage type slide case divided into upper and lower cases. An upper case 80 is used as an ordinary switching case, and a lower case 81 is used as a supercooling case as a supercooling space acting as a cooling chamber for placing food in a supercooled state. When the switching chamber 200 is pulled out, the switching case 80 and the supercooling case 81 are pulled out at the same time. When the supercooling case 81 is used, accommodated goods can be taken out from the supercooling case 81 by sliding the switching case 80 toward the rear side.

A gap of about 15 mm is formed between the upper case 80 and the lower case 81 around the periphery thereof. When a freezing temperature is set, cold air of about −20° C. is blown out from the cold air blowing ports 42, 43, and the like to the switching chamber. According to the above structure, the airflow blown into the chamber cools the inside and the periphery of the upper switching case 80 and flows into the lower case from the gap between the upper case and the lower supercooling case 81. However, since the gap is formed in a direction orthogonal to the airflow, the airflow is suppressed from directly flowing into the lower case so as to suppress an increase of the air temperature and the air velocity in the supercooling case 81. Further, in an ordinary cooling, the upper portion of the supercooling case 81 is covered with the switching case 80 so that the cold air can hardly flow thereinto in the structure thereof directly, and thus it is possible to perform gentle cooling necessary to create a supercooled state.

Further, a substance having a large heat capacity may be installed on the bottom 82 of the switching case 80 (for example, a metal plate, a case having a double-walled structure in which a heat storage medium is injected, and the like) so that the change of an air temperature can be suppressed thereby. With this arrangement, since the bottom 82 is disposed on the supercooling case 81, there can be obtained an effect of suppressing the fluctuation of the air temperature in the supercooling case 81, during ordinary use including the opening and closing operation of the door thereof.

A space of about 1 mm to 30 mm may be formed between the switching case 80 and the supercooling case 81. In this case, there can be obtained an effect in that when the cooling chamber is supercooled, it can be cooled well because the cold air flows into the supercooling chamber 81 and an effect in that the supercooled state can be effectively stopped because the cold air flows well at the time of stopping supercooled state. However, when the gap is too small, another opening must be formed to the lower case to perform quick cooling and direct cooling at the time when the supercooled state is entered or stopped. Thus, it is preferable to form the gap in the size of about 10 mm to about 30 mm.

Further, when an opening for stopping the supercooled state is formed, cold air need not be directly blown into the supercooling chamber 81 and cold air may flow thereinto by natural convection without a problem. Even if cold air is directly blown into the supercooling chamber 81, the same effect can be obtained by reducing the velocity thereof or increasing the temperature thereof as described already. As to the operation of the switching case 80 and the supercooling case 81 when the gap is formed therebetween, it is considered to slide the switching case 80 on guides attached to the supercooling case 81 through wheels mounted on the bottom of the switching case 80 or to slide the switching case 80 on the supercooling case 81 by inserting support columns disposed on the upper portion of the supercooling case 81 into grooves formed on the bottom of the switching case 80. Further, rails may be attached on a wall surface so that only the switching case 80 can slide along them forward and rearward. Note that even if no gap is formed between the switching case 80 and supercooling case 81, an appropriate cooling performance can be obtained. When no gap is formed, the fluctuation of an air temperature during ordinary cooling can be suppressed to a small range.

Further, since the case having a certain height is divided into the two stages as shown in FIG. 6, there can be also obtained an effect in that the goods accommodated in the case can be arranged well and thus the case can be used conveniently. Further, using the lower side of the two-stage case as the supercooling space is also effective in that the cooling property of the supercooling space can be improved due to the characteristics that cool air stays on a lower side and that when the upper case achieves a role for suppressing the airflow, which is blown out to the lower case, from directly flowing into the lower case, the fluctuation of the air temperature is suppressed. Note that the supercooling space may have a depth of about 70 mm, or may have a depth of at least about 140 mm, for example, a depth of about 300 mm to 600 mm supposing to store a frozen bread and a chilled large-size yoghurt cup.

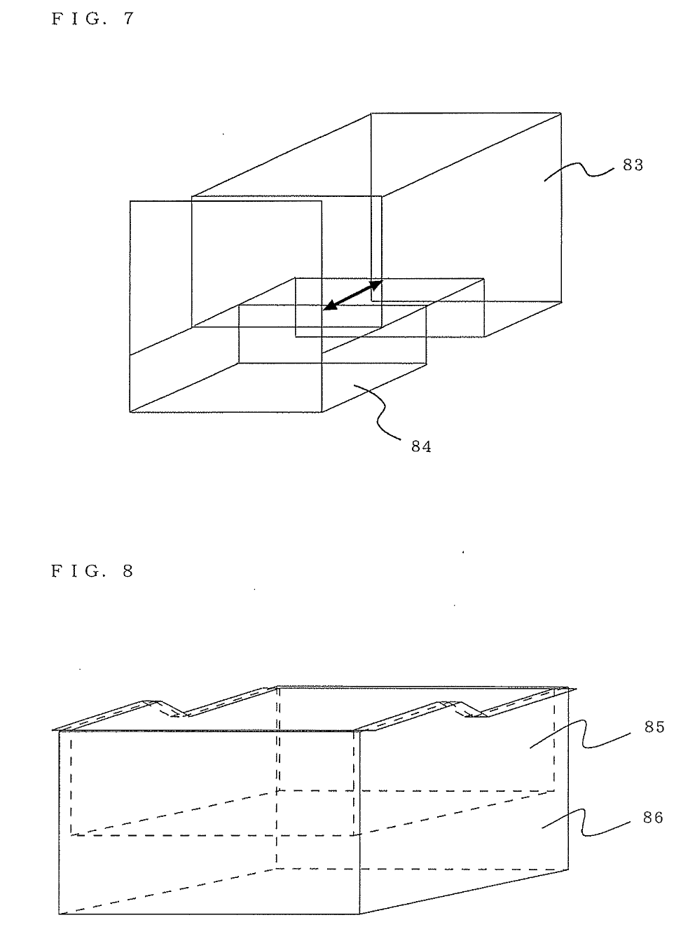

It is considered to set the depth of the upper case so that it has approximately the same capacity as that of the lower case or has several times the capacity of the lower case as shown in the drawing. Further, as a structure for using the lower side of the two-stage case as the supercooling space, a step may be formed to the bottom of the upper case as shown in FIG. 7 so that the front side and the rear side of the upper case has a different depth and the lower case is be disposed in correspondence to the stepped space of the upper case. In the FIG. 7, the upper case acts as a switching case 83, and the lower case acts as a supercooling case 84. The structure of FIG. 7 is advantageous in that tall foods can be accommodated to the back surface side of the switching case 83, and small goods can be accommodated to the door side thereof. The supercooling case has a gap between it and the upper case.

Further, a structure for using the lower side of the two-stage case as the supercooling space may be arranged as shown in FIG. 8. In the FIG. 8, an upper case acts as a switching case 85, and a lower case acts as a supercooling case 86. The switching case 85 and the supercooling case 86 need not always have the same depth and may have a partly open gap. Further, the switching case 85 may be arranged as an insertion type. Otherwise, the switching case 85 may be arranged as a slide type so that a food in the supercooling case 86 can be taken out by pushing the case inward. In the structure of FIG. 8, since the supercooling space can be provided only by adding the upper case, the structure has a merit in that a cost is less expensive when a modification is performed.

As explained already, it is necessary to somewhat restrict the cooling speed. In the foods, for example, pudding, yoghurt, and the like, the supercooled state is created by setting the cooling speed within the range of 300° C./h to 0.35° C./h and preferably near to 3.5° C./h in terms of the core temperature of the foods. This cooling speed is for the period until the time when the core temperature is made within the range from a freezing point to the temperature 20° C. lower than the freezing point and preferably within the range from the freezing point to −10° C.

Further, the supercooled state must be kept for a predetermined time and must be kept for, for example, at least five seconds. This is to make a supercooling temperature deeper. That is, this is to lower the temperature to which a food reaches in the supercooled state. As explained already, the reason why a deep supercooled temperature is preferable resides in that when the supercooled temperature is made deep, the amount of sensible heat energy accumulated in the supercooled state is increased. As a result, since the amount of energy of instantaneously changing latent heat, which is used during stopping the supercooled state, is increased, a lot of ice nucleuses are uniformly formed in food all at once making use of the energy during stopping the supercooled state, and ice crystals are grown using the ice nucleuses as the nucleuses thereof. Thus, since a lot of small ice particles are uniformly formed in the food, the ice crystals in cells less break the cells and suppress the flowing out of a drip at the time when the food is defrosted, thereby the cells are less affected aversely by the ice crystals.

Further, since no cold air is directly brown to food, an air velocity is suppressed, or a temperature fluctuation is suppressed, the food can be prevented from being dried and frosted. Further, there is a possibility that when food is placed in the supercooled state for a longer time, the temperature at which the food reaches to the supercooled state is lowered. As a result, since the degree of supercooled state is increased, the supercooled state must be kept for a certain time. Further, when a core temperature reaches to a supercooled state stop possible temperature, it is preferable that the difference between the core temperature and a surface temperature be within the range of 0° C. to 10° C. and preferably 5° C. or less. In the beef round having a thickness of 15 mm and a weight of 150 g, the difference between the surface temperature and the core temperature is about 1° C. It can be said that the range of the temperature difference as to the cooling condition described above is the same in the foods such as meats, fishes, vegetables, fruits, and the like.

The fluctuation of air temperature (difference of temperature with time) in the supercooling space is also important to keep the supercooled state. The range of fluctuation of air temperature is preferably within the range of 5° C. or less although it depends on the temperature and the air velocity around the food. However, when the range of fluctuation of air temperature is within the range of 10° C. or less, the supercooled state can be created although the quality thereof may be somewhat deteriorated. A reason why food quality is deteriorated at the time when the air temperature fluctuates greatly resides in that ice crystals are grown somewhat largely by repeating freezing and defrosting. Note that as another means for reducing the range of fluctuation of air temperature, the range of fluctuation of the predetermined value previously set to a microcomputer and the like to control the equipment based on the value detected by a thermistor (not shown in the figure), may reduced. The range of fluctuation is set to 4K (4° C.) or less and more preferably to 1K (1° C.) or less.

Further, although temperature difference caused by the location where uneven air temperature occurs in the supercooled space is acceptable at the time when it is within the degree of supercooled state, it is preferably within the range of the degree of supercooled state of about 2° C. in order to enter into the supercooled state. A problem caused by an excessively high uneven air temperature resides in that when it is intended to cool a large size food, it is partially frozen. That is, when an uneven temperature and the depth of a supercooled state are determined by an experiment regardless of the temperature of the supercooling chamber, in the case when the uneven temperature is made to 2K or less, the probability ratio of realizing the supercooled state approaches to 100%. Accordingly, it is important to suppress the temperature in the vicinity of food and reduce an air velocity. Further, the position and the size of the opening of the supercooling chamber are selected by determining the distribution of air flow and the distribution of temperature by simulation so that a temperature is not locally lowered by supplying the cold air to the entire supercooling chamber.

As a basis for setting the temperature for the supercooled freezing, the cooling speed and the like are satisfied as described already, and the temperature zone, in which the supercooled state occurs at a high probability, is set to, for example, −3° C. to −10° C. Since the freezing points of almost all of the foods, which are considered to be frozen, are included in this temperature zone, the foods can be stably frozen after entering the supercooled state. Further, since the food preservation period in this temperature zone is about two weeks, even if the foods, which were bought in bulk weekends, for example, are not completely consumed by a change of schedule and the like, they can be preserved at ease until the next week.

Further, when food is preserved after being frozen in the temperature zone, it can be divided by being cut with a kitchen knife. Therefore, the food can be cooked conveniently. When desserts such as yoghurt, pudding, and the like are supercool frozen, very fine ice crystals are created, so that a novel texture, which is different from that obtained from ordinarily frozen or refrigerated food, can be obtained. Further, when milk, juice, and the like are supercool frozen, sherbet having the texture different from that obtained from ordinarily frozen food can be obtained, and thus there is a possibility that a new menu specific to fine ice crystals can be made.

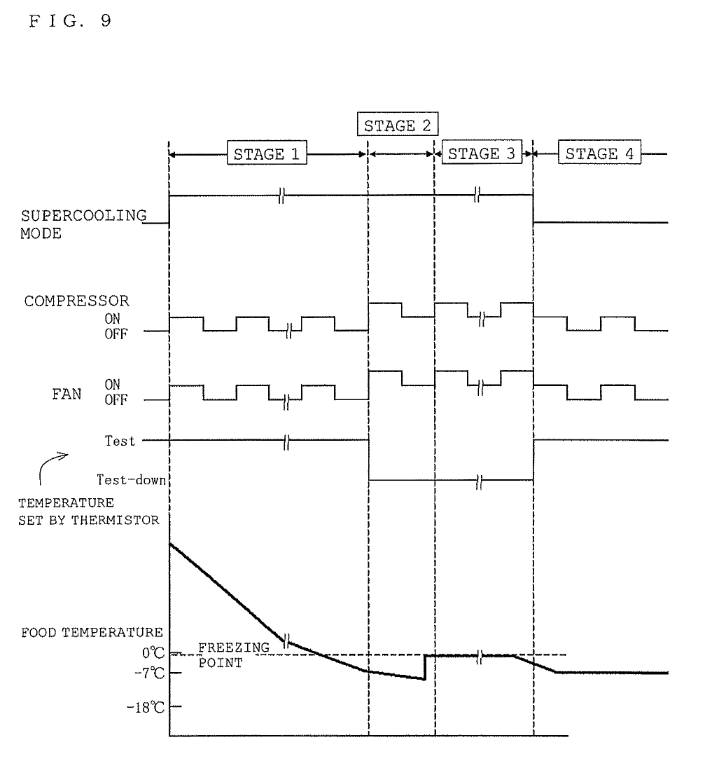

Next, the supercool control of the supercooling chamber (supercooling space) acting as the cooling chamber will be explained. It is assumed here that the timing of stopping the supercooled state is determined based on the cumulated time from the start of the supercooling, and the supercooled state is stopped by changing the temperature around the periphery of food to a low temperature. FIG. 9 is a timing chart showing the control of the refrigerator which is supercooling control stored in the controller 16. When the food accommodated in the supercooling space is supercooled, the compressor 10, the fan 2, the damper 46 and the like are operated to set the temperature in the chamber in which the supercooling case is located (here, the switching chamber 200) to the air temperature which is selected within the range of, for example, −2° C. to −20° C. until the core temperature or surface temperature in a case when the difference between the surface temperature and the core temperature of the food is small of the food in the supercooling case reaches to the supercooled state exceeding a freezing point (stage 1). Note that the compressor 10 and the fan 2 may be controlled by the temperature of another chamber, and the temperature may be controlled only by opening and closing the damper 46.

In the stage 1, the set temperature of thermistor (not shown) for setting the temperature of the switching chamber 200 is set to the same temperature as an ordinary temperature (shown by “set” in FIG. 9). After a supercooled state stop possible time (at which the food is supercooled up to a temperature at least 3° C. lower than the freezing temperature) is reached (after the supercooled state is kept for at least 5 seconds) (stage 2) and the supercooled state is stopped, the set temperature of thermistor may be set to the ordinary set temperature (Test) until the food is completely frozen in its entirety (stage 3). However, the temperature of the switching chamber 200 may be shifted down by lowering the set temperature (shown by “Tset-down” in FIG. 9).

In this case, the certainty for stopping the supercooled state is increased, thereby the quality of frozen food is also improved because the cooling speed is fast after stopping the supercooled state. Further, when the food is frozen instantly by performing quick cooling so that the temperature in the supercooling case is lowered to −20° C. or less as in an ordinary quick freezing, the quality of frozen food can be more improved. As to the setting of a preservation temperature after the food is completely frozen (stage 4), when a temperature such as −15° C. or more and the like on a high temperature side is set, an energy saving property can be increased and even if the food is preserved by being frozen at −5° C. to −10° C., it can be conveniently cut with the kitchen knife after it is taken out from the refrigerator, thereby the food can be easily used. Further, when the preservation temperature is set to a low temperature such as −15° C. or less, a preservation property can be increased.

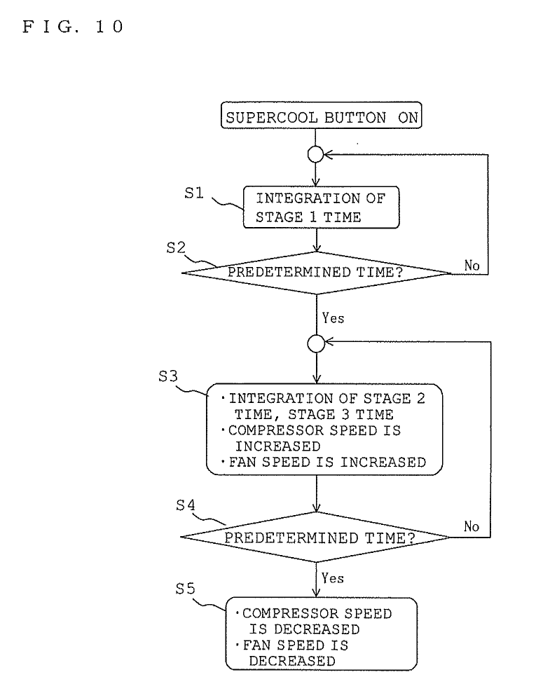

Summarizing the control operation of the controller 16 of the refrigerator 1 results in a flowchart shown in FIG. 10. When a supercooling button disposed to the liquid crystal panel 5 shown in FIG. 3 is depressed, the integration of a supercooling time is started (step 1). The time during which a supercooling temperature is reached from a room temperature is previously set to the range of 5 minutes to 72 hours and preferably to the range of 1 hour to 24 hour, and after the time has passed (step 2), the temperature in the inside of the supercooling case is controlled to automatically change to a low temperature side (step 3). Note that when an increase of temperature, which is caused by opening and closing a door in practical use, is detected by the not shown thermistor, only the time, in which the temperature is equal to or less than a predetermined temperature, is integrated. When it is determined that the integrated time of the stages 2 and 3 shown in FIG. 9 reaches to a predetermined time (step 4), the set temperature of the thermistor and the speeds of the compressor 10 and the fan 2 are returned to ordinary values (step 5).

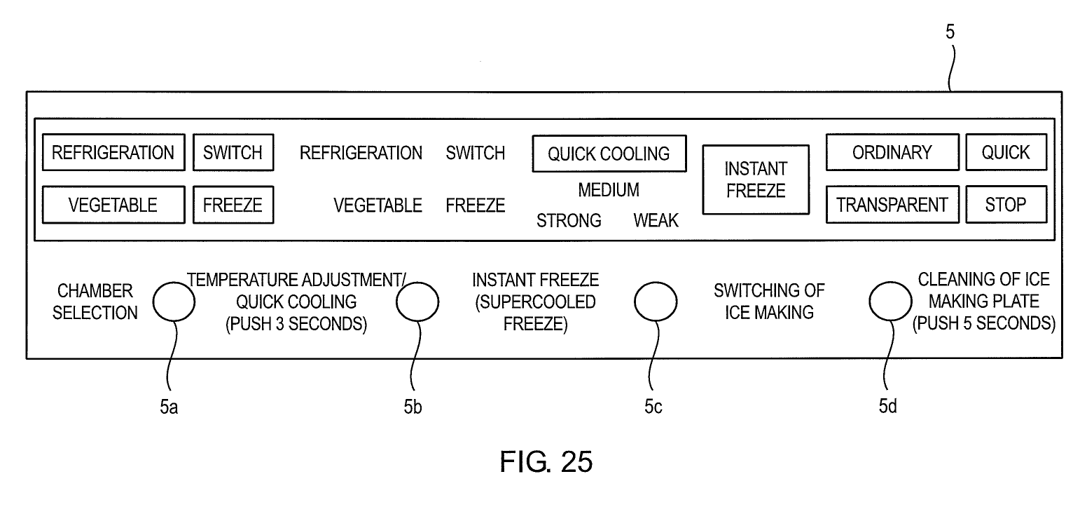

The switching chamber 200, which is the cooling chamber capable of placing the food accommodated therein in the supercooled state, can be switched to the plurality of temperature zones such as the refrigerating zone (about 3° C.), the chilled zone (about 0° C.), the soft freezing zone (about −5° C., −7° C., −9° C.), the freezing zone (about −17° C.), and the like, and these temperatures can be switched to set temperatures in such a manner that the controller 16 is composed of the microcomputer and the like disposed to an upper portion of the back surface of the refrigerator main body, controls the damper, the compressor, the fan, and the like. An example of the display panel 5 disposed on the front surface of the door is shown in FIG. 25.

FIG. 25 is a view showing the liquid crystal display panel showing an embodiment of the present invention. In the figure, reference numeral 5 denotes the display panel provided with a chamber selection switch 5a, a temperature adjustment/quick cooling switch 5b, a supercooled freezing (instant freezing) switch 5c, and an ice making changeover switch 5d. The chamber selection switch 5a selects any of the refrigerating chamber, the vegetable chamber, the freezing chamber, and the switching chamber, the temperature adjustment/quick cooling switch 5b selects the temperature adjustment or the quick freezing of a selected chamber (storage chamber), the supercooled freezing (instant freezing) switch 5c selects supercooled freezing (instant freezing), and the ice making changeover switch 5d selects ordinary, transparent, quick, or stop modes in an ice making mode.

The display panel 5 may display the set temperatures to the chambers (refrigerating chamber, freezing chamber, switching chamber, vegetable chamber, supercooling chamber, and the like) of the respective temperature zones and the present temperatures thereof. Further, when the surface temperature of food is measured by a non-contact type infrared ray sensor and a thermopile and the measured surface temperature of the food (for example, food temperature as shown in FIG. 9) is displayed on the liquid crystal display panel 5, a supercooled state and the surface temperature of the food can be found at a glance. This is convenient to a user of the refrigerator because it is not necessary for him or her to find a passed time as well as to confirm degree food is cooled by opening the door.

When it is desired to perform the quick freezing, a quick freezing mode is entered by continuously depressing the temperature adjustment/quick cooling switch 5b for a predetermined time (3 seconds), thereby the quick freezing is performed. Further, when it is desired to enter to the supercooled freezing (instant freezing), a supercooling mode is entered by depressing the supercooled freezing (instant freezing) switch 5c, thereby a supercooled cooling or the supercooled freezing is performed. Further, the refrigerator according to the embodiment of the present invention is provided with an ice-making pan cleaning mode, and the ice-making pan cleaning mode is entered by depressing the ice making changeover switch 5d for a predetermined time (about 5 seconds), thereby an ice-making pan is cleaned.

The temperature of a selected chamber (storage chamber) is adjusted by the temperature adjustment/quick cooling switch 5b, and, in the embodiment, the temperature is displayed in three levels of strong, medium, and weak. In the temperature display, a set temperature may be directly displayed on the display panel 5. Further, the temperature set to the cooling chamber is sequentially stepwise or continuously switched, when the cooling chamber is placed in the supercooled state, to the value to stop the supercooled state, and to the value when to stop the supercooled state and perform the frozen reservation. The set temperature can be automatically switched to the previously set temperatures based on the time intervals previously set by a timer.

However, these set temperatures can be also manually switched by providing the liquid crystal panel 5, which is disposed to the door of the refrigerating chamber 100, with a switch and the like. The temperature of the cooling chamber 200 from the time when the supercooled state of thereof is stopped to the time when it is further placed in a frozen reservation state is controlled by a cold air adjustment means such as the damper and the like so that the temperature of the cooling chamber 200 is made to a set temperature by detecting the temperature set to the not shown thermistor and the temperature of the chamber or by detecting the surface temperature of food. Note that it is matter of course that the compressor, the damper, and the like may be controlled using an infrared ray sensor for measuring a food temperature in place of thermistor for measuring a chamber temperature.

As described above, the temperature of the freezing chamber and the cooling chamber is set to a first set temperature with respect to the supercooled state, and food is placed in the supercooled state by the cold air introduced into the cooling chamber. Next, a temperature difference is previously stored, and the supercooled state of the food is stopped by a temperature which is lower than the first set temperature by the temperature difference. When it is determined that the supercooled state is stopped by the surface temperature of the food, cold air is adjusted according to a third temperature set by the changeover switch of the door of the refrigerator to preserve the food in a frozen state. As described above, since the first set temperature, a second set temperature, and the third set temperature are sequentially changed at time intervals or by measuring the temperature of the food, the cold air can be adjusted by a simple structure of software stored in the microcomputer. As a result, the frozen reservation, by which food can be frozen in good quality, can be realized with a smaller amount of energy without performing quick freezing or without setting a ultra low temperature of −60° C. When the time intervals are set, they may be previously stored time intervals, or a time may be set by the liquid crystal panel 5 on the surface of the door. With this arrangement, a quick processing can be performed according to a food. Further, the degree of supercooled state can be made deeper by determining the timing of stopping the supercooled state by measuring the temperature of food.

To pace the accommodated food in the supercooled state, the supercooled state is entered by adjusting the amount of the cold air introduced into the cooling chamber, the temperature of the cold air being set by the first temperature, which is the temperature stored in the microcomputer, of the freezing chamber and the cooling chamber in which the food is accommodated, and the supercooled state is continued. Next, the supercooled state is continued, and after the time, which is set as the time necessary to continue the supercooled state, has passed, the supercooled state of the food is stopped by supplying cold air whose temperature is lower than the first temperature, and the food, which is released from the supercooled state is preserved in a frozen state at a third temperature set by a temperature setting unit disposed on the surface of the door.

When it is assumed that the first set temperature is previously stored, since the third temperature to be set can be simply switched manually, so that temperatures can be set with no relation with each other. However, when the first temperature is set, the temperature setting unit may be disposed on the surface of the door of the refrigerator or a side surface of the cooling chamber so that the first temperature can be switched according to a type of food. It is also possible to display the temperature set state and the detected temperature of the surface of the food on the liquid crystal panel 5, and it is also possible to change the setting temperature while observing the displayed state of it. The third temperature may be set so that it can be switched to a deep temperature zone from −30° C. to −60° C. in consideration of a long time preservation of several months or longer, to a weak freezing temperature zone in which a person can cut food making use of a kitchen knife and the like due to the ice crystals from −5° C. to −15° C. created therein, or to an intermediate freezing temperature zone between the above temperature zones.

When a temperature is set, the controller controls the number of revolution of the compressor and opening or closing of the damper so that the temperature detected by the sensor is set to the temperature set by being switched. As described above, since the first and third set temperatures can be set with no relation with each other, respectively, the set temperature can be changed according to a preservation period and a state of use, according to a period of time during which a necessary supercooled state is continued depending on a season and a type of food to be accommodated, or according to the depth of the supercooled state, so that flexible freeze preservation can be obtained.

Further, when the temperature of the indirectly cooled cooling chamber is set, it can be determined whether or not the first temperature, which is set to place food in the supercooled state, is set by measuring the temperature of the cabinet by a sensor disposed in the cooling chamber or by estimating the elapsed time of the chamber temperature of a wall surface being cooled. It is possible to stop the supercooled state by lowering the temperature of the wall surface by lowering the temperature of the cold air for indirectly cooling to a temperature lower than the first temperature for placing the food accommodated in the cooling chamber in the supercooled state. Otherwise, the supercooled state may be stopped by increasing the heat transmission ratio of the surface of the food by increasing the air velocity around the periphery of the food by increasing the number of revolutions of the blowing fan in the sealed cooling chamber. A more uneven temperature distribution of the surface of the food can more easily stop the supercooled state. A cold air is directly introduced into the cooling chamber, in which the supercooled state is stopped by such a supercooled state stop means for stopping the supercooled state of the food, by opening the opening of the cooling chamber, to preserve the food in a frozen state. Otherwise, the food in the chamber may be preserved in a frozen state by more lowering or keeping the temperature of the wall surface while it is being indirectly cooled. As described above, the freeze preservation, which consumes a smaller amount of energy, can be performed by the simple structure.

Next, an embodiment, in which the two-stage case is not used, will be explained. FIG. 11 is a side sectional view of a switching chamber 200 in the embodiment 1 of the present invention. The same reference numerals as those of FIG. 5 show the same arrangements. A partition wall 41a is disposed in a switching chamber air duct 41 to adjust the distribution of cold air to switching chamber back surface upper side blowing port 42 and a switching chamber ceiling surface blowing port 43 on the front side of a ceiling surface, and the cold air is distributed by the opening/closing angle of a damper 46. Reference numeral 95 denote a device, for example, an infrared ray sensor for measuring the surface temperature of food to be frozen by supercooling.

It is disposed on the ceiling surface 96 of the switching chamber 200 and can detect the surface temperature of the food. Note that when the blowing port 43 is located on the front side of the ceiling surface 96, the surface temperature measuring device 95 is disposed, for example, rearward of the ceiling surface 96 as a position at which it is not affected by the cold air from a ceiling surface blowing port 43. In contrast, since the cold air from the back surface blowing port 44 has a stronger stimulation to the food than that of the cold air from the blowing port 43, the surface temperature measuring device 95 is disposed on the ceiling surface 96 in the upper portion of a back surface so that the state of the food affected by the cold air from the blowing port 44 can be easily detected.

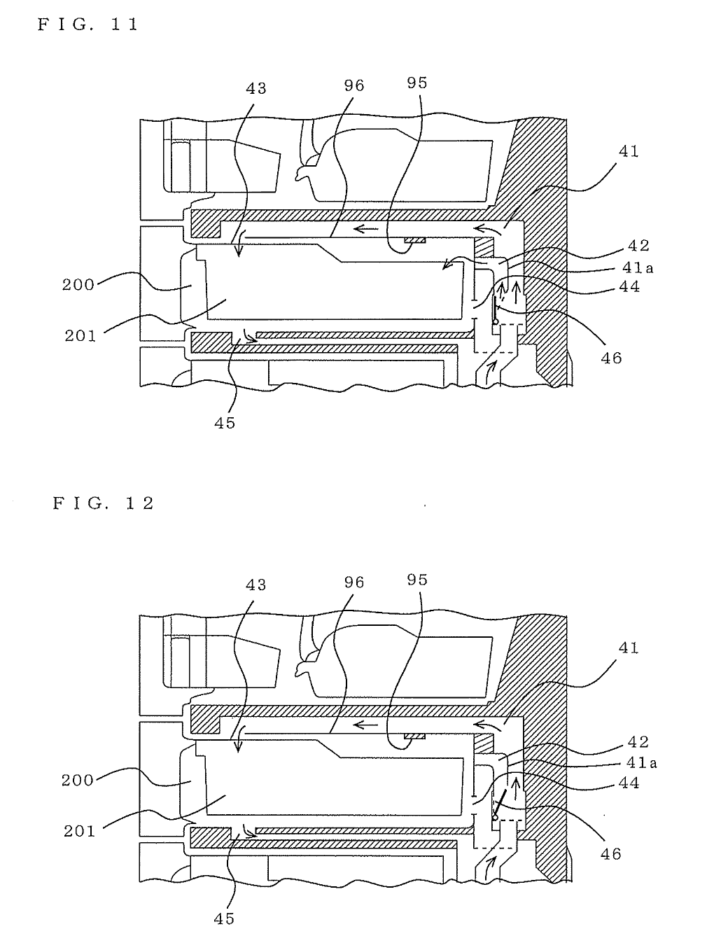

Next, a supercooling control of a cooling chamber for placing a food accommodated therein to a supercooled state, that is, a supercooling chamber (supercooling case) will be explained. To supercool the food accommodated in the supercooling case, the difference between the core temperature and the surface temperature of the food is reduced while detecting the surface temperature of the food with the surface temperature measuring device 95, so as to prevent that the food begins to freeze before the core temperature of the food in the supercooling case reaches the freezing point because of the surface temperature of the food excessively lowered. The air velocity of the cold air, which flows into the supercooling case, is reduced by increasing the amount of cold air distributed to the blowing port 43 by, for example, half-opening the opening/closing angle of the damper 46 to the position of the partition wall 41a as shown in FIG. 12.

Further, since the temperature of the cold air is increased by increasing the length of the air duct 41 through which the cold air passes, there is an effect in that the surface of the food is not abruptly cooled because the temperature of the cold air from the blowing port 43 is made higher than the cold air flowing in from the blowing port 42 near to the damper 46.

The temperature set to the switching chamber at the time is made higher than the temperature ordinarily set to a freezing chamber. The food is cooled as described above until the core temperature thereof reaches to the freezing point, and when it is determined that the surface temperature is made to such a temperature that the freezing point is reached, the food is rapidly cooled to lower the lowest reach point of the temperature of the food. This is because since a temperature equal to or less than the freezing point is in an unstable state, in a case when the temperature of food is lowered slowly, there is a possibility that the supercooled state is stopped while the reach temperature in the supercooled state is kept high.

Accordingly, when the temperature of the surface temperature measuring device 95 is reached to a temperature at which it is determined that the freezing point has been reached, a temperature control is performed so as to lower the lowest reach point temperature by increasing the amount of cold air flowing into the supercooling case by increasing the number of revolution of a fan or by increasing the intake amount of cold air by totally opening the damper 46 (the state of the damper 46 in FIG. 11). The temperature set to the switching chamber at the time is set to the same temperature as the temperature cooled up to the freezing point or is lowered. Next, when the food is released from the supercooled state, the temperature of the surface temperature measuring device 95 is increased. This is caused by the phenomenon that when the food is released from the supercooled state, the temperature of the food is increased to the freezing point, and thus ice nucleuses are created by the heat energy corresponding to the difference between the freezing point and the supercooled state reach temperature (heat energy corresponding to an increase of temperature).

The temperature is controlled to completely freeze the food by blowing cold air into the supercooling chamber in response to the above determination. Cold air having a lower temperature is caused to flow into the supercooling chamber by totally opening the damper 46 and increasing the numbers of revolutions of the fan and the compressor. At the time, the temperature set to the switching chamber is made lower than an ordinary temperature. As described above, setting control is changed continuously or stepwise through the respective steps of a freezing point of the food, a supercooled state lowest achieve point temperature from the freezing point, stop of the supercooled states, and complete freezing. For example, the supercooled state is securely achieved by controlling the temperature, the amount, and the velocity of the cold air to the supercooling case, the supercooled state lowest achieve point temperature is lowered, the supercooled state is stopped, and a freezing speed is increased after stopping the supercooled state, so that good quality freezing can be realized.

In contrast, when the temperature of the surface temperature measuring device 95 does not lower from the freezing point even after a predetermined period of time, it is determined that no supercooled state is caused in the food (failure of supercooling), a phase is changed from the freezing point, and a frozen state is entered. Accordingly, a temperature control is performed so that quick freezing can be performed likewise the temperature control after stopping the supercooled state, and that ice crystals can be formed finely even if freezing is performed without through the supercooled state in order to keep the quality of frozen food as far as possible. As a temperature control without a failure, the temperature of, for example, meat is controlled at −1° C. which is the freezing point thereof until the freezing point is reached and the meat is uniformly cooled until the core temperature thereof is cooled to the freezing point of −1° C.

Next, the supercooled state reach temperature is lowered while controlling a set temperature to be about −4° C. to −7° C. Since the supercooled state lowest reach point temperature cannot be lowered to a temperature equal to or less than a cooling temperature, when it is desired to set a temperature −3° C. lower than the freezing point, it is necessary to perform cooling at a temperature equal to or less than −4° C. However, when an excessively low temperature is set, the supercooled state is stopped regardless that the lowest reach temperature can not be lowered. Therefore, the temperature is set to −7° C. When the supercooling lowest reach point reaches to a temperature −3° C. or less lower than the freezing point (the same effect as that when the supercooled state is kept for 5 seconds or more), a control for stopping the supercooled state is performed to thereby stop the supercooled state. After stopping the supercooled state, a quick cooling control is performed to quickly freeze the food. When a food is preserved so that it can be simply cut with a kitchen knife (preserved at −5° C. to −10° C.), it is preferable to perform a temperature control not to lower the temperature of the food below −10° C. to prevent the already preserved food from being not cut. Since this is not necessary in the freezing temperature zone, the food is quickly cooled at a lower temperature.

Note that although the supercooled state and the supercooled state lowest reach point temperature can be realized by a stepwise temperature control even in an environment in which an air velocity is slow due to natural convection and the like, the same effect can be also obtained by controlling the air velocity and the temperature of the cold air. Further, when a quick cooling control is performed to perform quick cooling and to use the switching chamber with freezing setting, a quick cooling speed can not be obtained by the natural convection. Whereas when the cold air is allowed to directly flow in as in the embodiment, quick cooling is possible. Further, when the supercooled state is kept or stopped at time intervals, a supercooled freezing time can be reduced, and the quality of frozen food can be improved. As a result, this system can be widely used in that the space, in which foods are subjected to the supercooled freezing, can be effectively used and that foods, which are not supercooled, can be mixedly stored in the cooling chamber. Although, a lid and the like are not disposed to the opening in the upper portion of the supercooling case in the embodiment, the same effect can be also obtained by controlling the amount and the velocity of cold air by the lid and the like additionally. At the time, the lid need not completely cover the opening in the upper portion and may cover it in the range in which it can control the amount and the velocity of cold air.

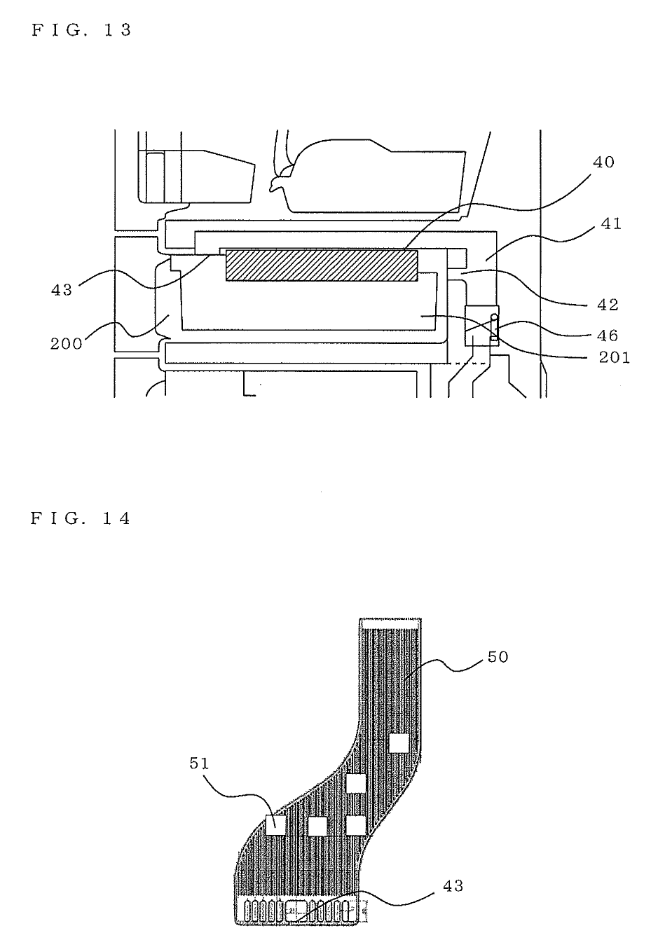

Next, an example in which an upper stage case of a switching case 201 composed of upper and lower stage cases is used as the supercooling case will be explained. FIG. 13 is a side sectional view of a switching chamber 200 corresponding to FIG. 5 in the embodiment 1 of the present invention. As shown in FIG. 13, the upper stage case of the switching case 201 composed of the upper and lower two stages is used as a supercooling case 40. The supercooling case 40 is disposed rearward of a switching chamber ceiling surface blowing port 43 and has such a structure that it can be slidingly pulled out. According to the structure, since the cold air from the switching chamber ceiling surface blowing port 43 is not directly applied to the inside of the supercooling case 40 and the food accommodated therein, a temperature can be kept in a stable state.

FIG. 14 is an upper surface view of a duct 50 connected to the switching chamber ceiling surface blowing port 43. Holes 51 may be formed in the midway of the duct 50 to cause the cold air flowing in the duct 50 to naturally fall downward in order to more cool the supercooling case 40.

When the supercooling case of FIG. 13 is used, the independent type supercooling case 40 is pulled out by drawing out the switching case 201. Since the supercooling case 40 is pulled out only when it is used, there is a merit in that the temperature of the supercooling case 40 is unlikely to increase when the switching chamber 200 is used. Further, disposing the supercooling case 40 on the switching chamber 200 is advantageous in that a new case can be added without changing the size of the conventional switching case.

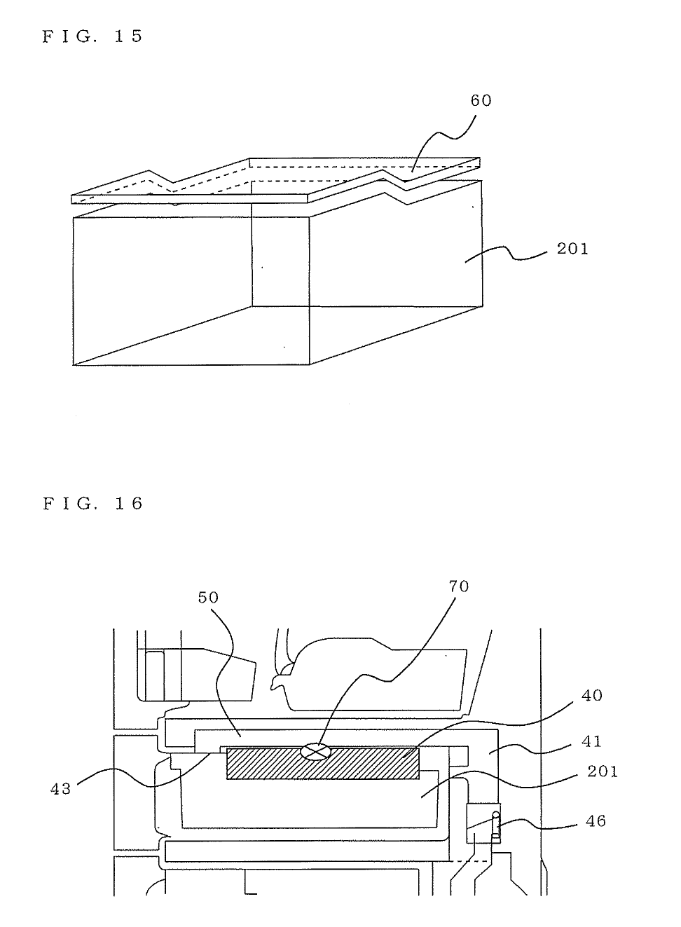

Next, the structure of the supercooling case will be explained. FIG. 15 is a structure view of the supercooling case in the embodiment 1 of the present invention. Here, the switching case 201 disposed to the switching chamber 200 is arranged as the supercooling case in its entirety by covering the upper portion thereof with a lid 60. FIG. 15 shows an example showing that the supercooling case is formed by the switching case 201 entirely covered with the lid 60. Note that the switching case 201 may have such a structure that a partition is disposed in the inside thereof in a longitudinal direction or a lateral direction, and only a part of the partitioned portion is covered with the lid 60 so that it is used as the supercooling case.

Since no cold air is directly blown into the space arranged as the supercooling case provided with the lid 60, the inside of the case is indirectly cooled completely. Further, the temperature in the supercooling case formed as described above is hardly fluctuated and further the case can be realized at the lowest cost. Note that it is also possible to use a case without the lid 60 as the supercooling case, which can be cooled without being supplied with air, by, for example, making use of radiant cooling performed by cooling a wall with cold air or a refrigerant circulating inside of the wall.

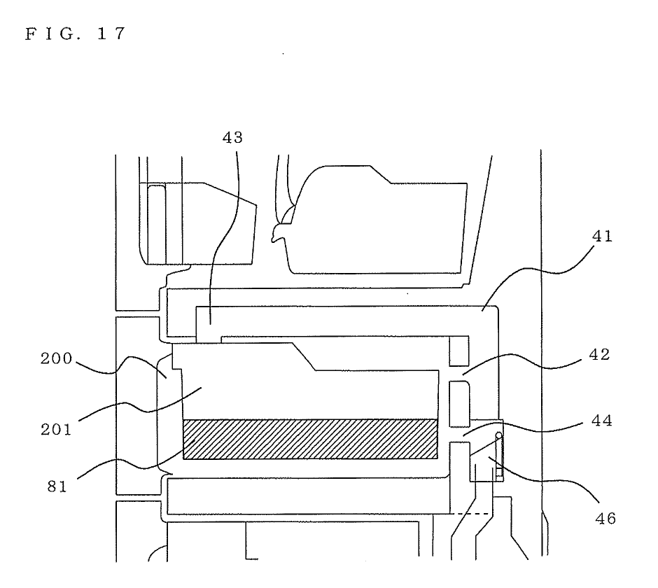

Next, a structure, in which the switching chamber is provided with a fan, will be explained. FIG. 16 is a side sectional view of a switching chamber 200 corresponding to FIG. 5 in the embodiment of the present invention. As shown in FIG. 16, in the embodiment, the fan (switching chamber fan) 70 is disposed to the upper portion of the switching chamber 200. According to the arrangement, since the air in the switching chamber 200 can be slowly stirred by the operation of the fan 70, an air temperature can be uniformly kept without increasing a cooling speed. Although a large food may be charged into the supercooling case 40, since the food can be prevented from being unevenly cooled in its entirety in the structure, so that supercooling can be stably caused. The supercooling case 40 may be disposed in any potion in the switching chamber 200, and the supercooling case 40 may be arranged as an independent case to the switching case 201 or the entire switching case 201 may be arranged as the supercooling case 40.

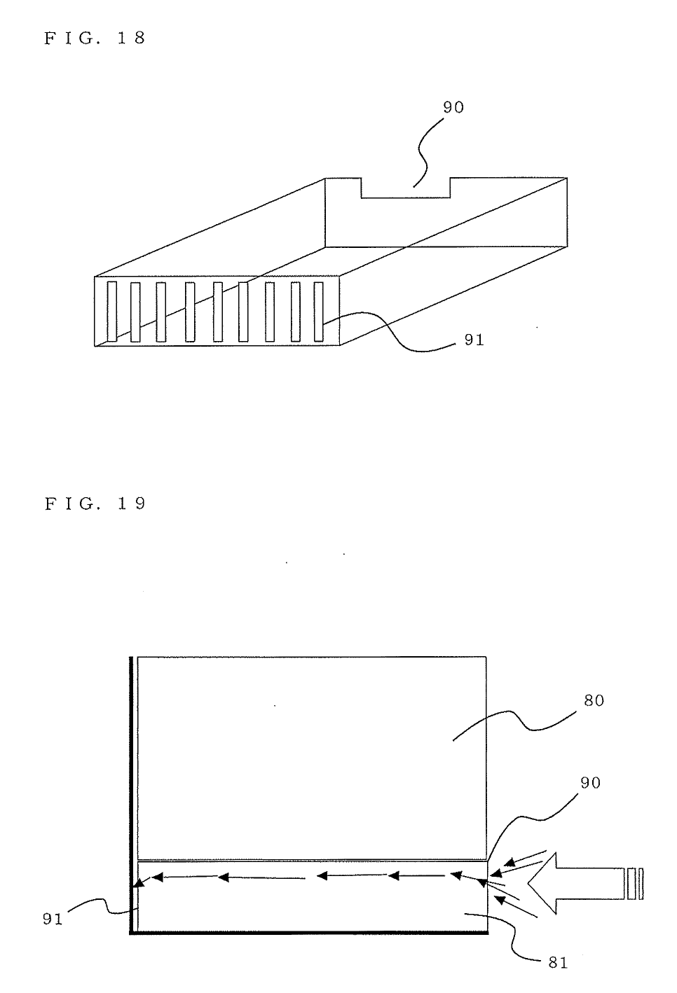

Next, an arrangement, in which a supercooling case for forming a supercooling space is disposed under the switching case in the switching chamber, will be explained. FIG. 17 is a side sectional view of a switching chamber 200 corresponding to FIG. 5 in the embodiment 1 of the present invention. FIG. 18 is a perspective view of the supercooling case used in the embodiment. FIG. 19 is a view showing the flow of cold air to the supercooling case in the embodiment. As shown in FIG. 17, the supercooling case 81, constituting the supercooling space, is disposed under the switching case 201 in the switching chamber 200. A switching chamber air duct 41 is disposed around the switching chamber 200, and further there are provided three blowing ports, that is, a switching chamber back surface upper side blowing port 42, a switching chamber back surface lower side blowing port 44, and a switching chamber ceiling surface blowing port 43 from which the cold air from the cooler 3 is blown out.

Further, a damper 46 is disposed to the inlet of the switching chamber air duct 41 to adjust the amount of cold air flowing toward the switching chamber 200. As shown in FIG. 18, a cutout 90, into which the cold air from the switching chamber back surface lower side blowing port 44 flows, is formed to the back surface of the supercooling case 81 used here, and slits 91, from which the cold air flowing thereinto from the cutout is discharged, is formed to the front surface of the case. Since the cold air from the cooler 3 flows in the supercooling case 81 as shown by an arrow of FIG. 19, it is preferable to adjust the flow amount thereof by a flow amount adjustment unit such as the damper 46 when supercooling is performed and when the supercooled state is stopped. Note that the arrangement, of forming a cutout and an opening through which cold air flows to the back surface of the case and forming slits and openings for discharging the cold air flowing into the front surface of the case, can be applied to any supercooling case of the embodiment 1.

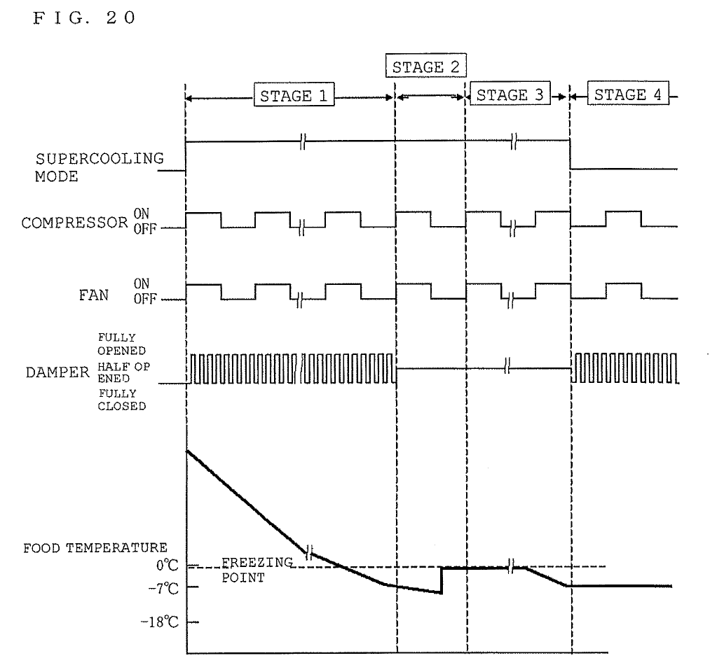

Next, the supercool control of the refrigerator in the embodiment 1 making use of the supercooling case 81 shown in FIG. 17 and FIG. 18 will be explained. FIG. 20 is a timing chart showing an example of the supercool control. To supercool the food accommodated in the supercooling case 81, the compressor 10, the fan 2, the damper 46, and the like operate to set the inside of the switching chamber 200 to an air temperature selected in the range of, for example, −2° C. to −20° C. until the core temperature of the food accommodated in the supercooling case 81 exceeds a freezing point and reaches to a supercooled state (stage 1). Note that the temperature may be controlled only by opening and closing the damper 46 by controlling the compressor 10 and the fan 2 based on the temperature of other chambers.

Here, the damper 46 repeats full opening/closing as usual. When the core temperature of the food is reached to the temperature at which supercooling can be stopped, (stage 2), cold air is caused to mainly flow into the supercooling case 81 side by half-opening the damper 46. The half-opened angle of the dumber 46 may be any angle as long as a lateral vector is applied to an airflow. The angle is preferably 10° C. to 60° C. The period of time during which the damper 46 is half-opened is set to the period of time until freezing is completed after stopping the supercooled stated (stages 2, 3). After the completion of freezing of the food, a preservation period (stage 4) is controlled by returning the damper 46 to the state in which it is fully opened and closed repeatedly as usual.

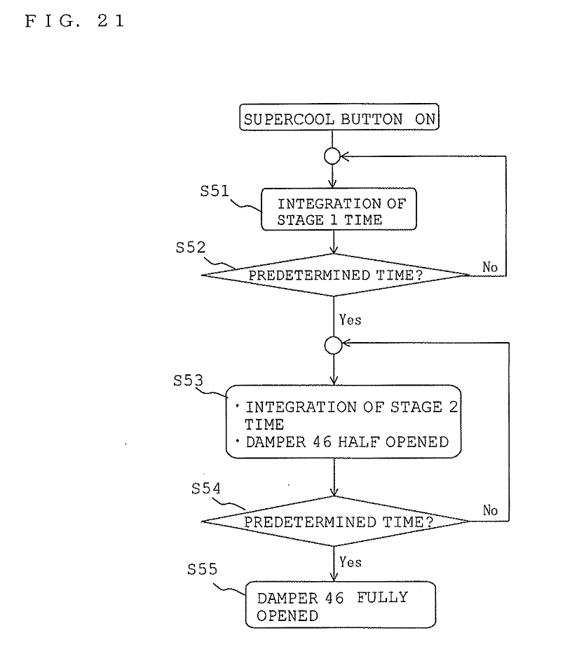

The summary of the control operation of the refrigerator 1 as described above is as shown in a flowchart of FIG. 21. When the supercooling control is started, the period of time of the stage 1 starts to be cumulated (step 51). Next, whether or not a predetermined time has passed in the stage 1 is determined (step 52), and when it is determined that the predetermined time has been reached, the damper 46 is half-opened and the period of time of the stage 2 starts to be cumulated (step 53). Then, it is determined whether or not a predetermined time has been passed in the stage 2 (step 54), and when it is determined that the predetermined time has been reached, the damper 46 is fully opened, and the process is returned to an ordinary control (step 55).

Since almost no cold air flows into the supercooling case 81 in the control for obtaining the supercooled state, the supercooled state can be created stably. And freezing can be securely caused after stopping supercooled state since almost all the cold air is caused to flow into only the supercooling case 81 during stopping the supercold state. Further, there is also merit in that the influence to the air temperature of the switching case 201 is almost eliminated when stopping the supercooled state. In addition to the above, the fluctuation of the air temperature may be suppressed by adjusting the amount of cooling by changing the degree of opening of the damper 46 and adjusting the amount of air in the switching chamber 200.

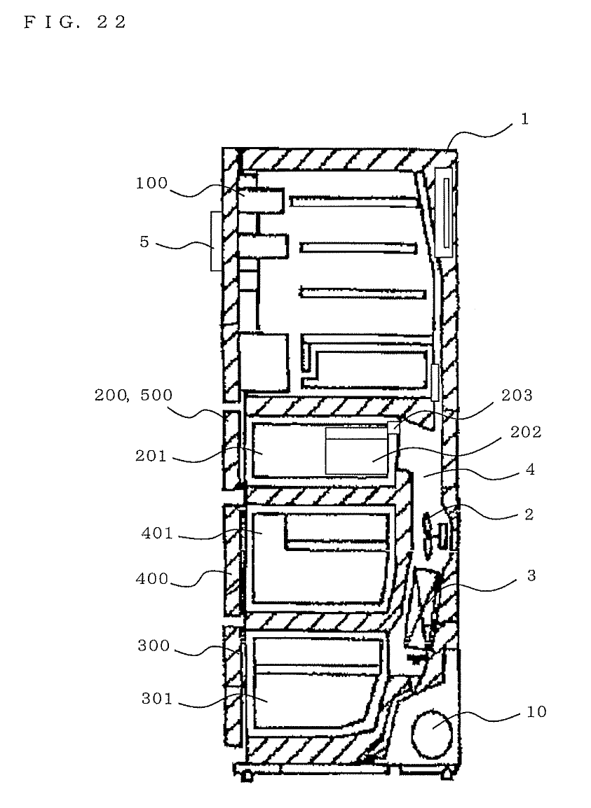

FIG. 22 is a sectional view where a supercooling case 202 for supercooling, which is provided with a lid and installed separately, is disposed in the switching chamber of the refrigerator of FIG. 3. Here, the supercooling case 202 is disposed at such a position that the cold air from a blowing port 203 flows on the upper surface of the supercooling case 202. FIG. 23 shows how the supercooling case 202 is disposed in the switching case 201. As described above, when the supercooling case 202 is composed of the case with the lid disposed separately, there can be obtained a merit in that even if a food having a different temperature state is accommodated in a vicinity, the food in the supercooling case 202 is unlikely to be affected by it.

Further, a heat insulating material may be inserted into the lid portion of the supercooling case 202. In this case, there is a merit in that supercooling can be stably caused because the supercooling case 202 is unlikely to be affected by the cold air from the blowing port 203. Further, since the uneven temperature caused by directly blowing cold air, may act as a factor for stopping supercooling, the lid may be partly or entirely composed of a material having good heat conductivity or the number and the position of blowing ports, the shape of the blowing ports, and the positional relation between the blowing ports and the lid may be designed so that they are within the range of predetermined temperature unevenness. The range of the predetermined temperature unevenness is within 10K, preferably within 5K, and more preferably within 2K.

Note that in all the embodiments explained heretofore, when the switching case and the supercooling case are partially or entirely composed of a material having good heat conductivity (a metal plate of, for example, stainless steel, aluminum, copper, and the like), the temperature in the cases can be made uniform. The temperature can be also made uniform by composing the cases of a double-wall structure. Further, when the cases are provided with a heat accumulating agent capable of absorbing the heat capacity of food, a supercooled freezing time can be more shortened.

The method of controlling the timing of stopping supercooled state, based on the time previously recorded to the microcomputer and the like is explained above. Another method of determining the timing of stopping the supercooled state will be explained. As explained already, when the temperature of the cooling chamber is continuously lowered to make the supercooled state deeper for example, when the temperature is lowered to a temperature lower than −10° C. a probability for causing the supercooling to be automatically stopped is increased. Occurrence of the automatic stopping can be discriminated because the temperature of food is increased. When the automatic stopping or a forcible stopping occurs, it is preferable to confirm the timing of the stopping by measuring it with a sensor. The timing of stopping the supercooled state can be determined by determining the state of a supercooled food using an infrared ray sensor, an ultrasonic wave sensor, an electric field sensor, and the like.

When the infrared ray sensor is used, it is disposed on the wall surface of the space in which the supercooling case is disposed so that the sensor can movably observe the overall inside of the case, or the infrared ray sensor is composed of an array sensor so that it can observe the overall inside of the case. The infrared ray sensor is disposed on, for example, the back surface of the switching chamber 200 so that it can be observe the supercooling case entirely from the oblique upper side thereof. When the supercooling mode is entered, the infrared ray sensor can detect the change of the surface temperature of a food in the supercooling case by detecting the surface temperature thereof. The stopping can be easily found by the change of the surface temperature.

Further, the core temperature of the food is calculated from the detected surface temperature. Then, stimulation can be applied to stop the supercooled state when it is determined that the calculated core temperature of the food reaches to the temperature, which is shown by the above supercooling condition and stored in the microcomputer and the like after being previously set. With this operation, the period of the time of the supercooled state can be shortened. There is naturally the case that the difference between the surface temperature and the core temperature is small. Thus, it is also possible to make the degree of supercooled state deeper by more lowering a cooling temperature by placing a priority on the determination of a small temperature difference even at the time when the time interval set to the control reaches to a time for performing stopping. As described above, a complex determination can be simplified making use of the surface temperature measurement.

When the ultrasonic wave sensor is used, the supercooling case is caused to come into contact with the ultrasonic wave sensor. The ultrasonic wave sensor is composed of an oscillator for oscillating an ultrasonic wave and a receiver for receiving the reflected wave of the ultrasonic wave. The ultrasonic wave sensor may be disposed in any location as long as it comes into contact with the supercooling case when the door thereof is closed. When the ultrasonic wave sensor is disposed on, for example, the back surface of the switching chamber 200 through a spring disposed on a sensor rest, the cost thereof can be reduced by minimizing a wiring length as well as the sensor can be caused to securely come into contact with the case when the switching chamber is closed. When the supercooling mode is entered, the ultrasonic wave sensor oscillates the ultrasonic wave toward the food in the supercooling case.

Since the ultrasonic wave is transmitted in the substance in contact. Therefore, when the sensor comes into contact with the case, the ultrasonic wave is also transmitted to the substance accommodated in the case and brought into contact with case. At the time, when the supercooled state is stopped and ice crystals are created, since the ultrasonic wave can be more easily transmitted as compared with the case where food is in an not-frozen state or in a supercooled state in which water in the food exists as a liquid, so that the oscillated ultrasonic wave reaches to the receiver at a faster speed. Since it can be found from the difference between the times or between the transmission speeds that the supercooled state is stopped and the water in the food begins to freeze, thereby the process can go to the control to be performed after stopping the supercooled state.

When the electric field sensor is used, it is disposed in the supercooling space. An electrode of the electric field sensor may be formed in any shape as long as it is composed of metal. When the electrode is composed of, for example, a foil so that it can be conveniently bonded on the inner box and the like of the refrigerator, the foil can be bonded along the irregular portion of the inner box. When the electrode portion is formed to a sheet shape which is thicker than the foil, there can be obtained an electrode with no possibility of breakage at the time of attaching. Further, since the electrode is of a non-contact type, it can be disposed to any portion on the wall surface of the refrigerator, and it can perform measurement even if another substance, for example, a plastic sheet is located between the electrode and a substance desired to be measured. The output of the electric field sensor is changed by the dielectric in food. When a supercooled state is stopped and ice crystals are created, the dielectric is greatly reduced as compared with the case that the food is in a not-frozen or supercooled state in which water exists as a liquid. Thus, the timing, of stopping the supercooled state, can be determined making use of the large reduction of the dielectric, and the process can go to the control to be performed after stopping supercooled state.

Further, stimulation may be applied to stop the supercooled state by determining the timing of stopping the supercooled state by directly measuring the temperature of food by a thermometer, in addition to using the above sensors. The thermometer is connected to the refrigerator through a wiring and has a needle-shaped extreme end. When a food is charged into the supercooling case, a user inserts thermometer into the food whose temperature is desired to be measured. With this operation, since the temperature in the food can be measured, the user can directly recognize whether or not the temperature has sufficiently reached to a predetermined supercooling temperature. When the inside of the food has been reached to a sufficient supercooling temperature, the process can shift to the control for stopping the supercooled state.

Next, another method of stopping the supercooled state, which is different from the method of stopping the supercooled state by reducing a temperature or introducing cold air as explained above, will be explained. The another method of stopping the supercooled state includes, for example, a method of applying vibration or a sound wave to the supercooling case, and the like. The method of applying vibration includes a method of using a machine, a method of making use of the vibration of equipment operating in the refrigerator, and the like. Another method of cooling only supercooling case and not lowering the temperature of the switching case during stopping the supercooled state includes, for example, a method of disposing a heater on the wall around the switching case and heating only the switching case side by the heater during stopping the supercooled state. Further, there is also a method of, for example, disposing a heater on the wall around the supercooling case, turning on the heater to heat the supercooling case during supercooling, and turning off the heater during stopping the supercooled state, and the like. Note that the supercooled state need not be always stopped. The supercooled state may be kept and left as it is.

The structure of the supercooling space, the method of determining the timing of stopping the supercooled state, the method of stopping the supercooled state, and the like have been explained above in relation to the embodiment of the present invention. Next, a method of preserving food after stopping the supercooled state will be explained below.

When food is preserved in a frozen state within the temperature range of −10° C. or more after stopping the supercooled state, the food can be kept in a state in which it can be cut well with a kitchen knife even after being frozen. Since the food is frozen through the supercooled state, the ice crystals in the food are made fine, from which an advantage can be also obtained in that the food can be cut more easily than that in ordinarily freezing. Further, since a preservation temperature zone is set equal to or less than a freezing point, food can be preserved for a somewhat longer period of about 2 weeks.

In a case where food is preserved within the temperature range of −10° C. to −15° C. after stopping the supercooled state, since fine ice crystals are created in the food in the system of the present invention, so that there is an advantage in that the food can be cut with the kitchen knife, in contrast with an ordinary greezing method in which ice crystals are largely grown in a needle-shape, so that the food can not be cut with a kitchen knife after being frozen. Further, as to the preservation period, the food can be preserved for a long period of about 2 weeks or more to about 1 month.

When food is preserved in the temperature zone of −15° C. or less after stopping the supercooled state, it can be preserved for about 1 month like ordinarily frozen food. Further, ice crystals are made fine and unlikely to break the cells of the food, it is possible to get a better taste, the better texture, and the like as compared with ordinarily frozen food.

As a means for changing the preservation temperature, there is a method of switching a temperature in one chamber. Further, a chamber in a somewhat higher freezing temperature zone may be used to subject food to supercooled freezing, and the food may be moved to a chamber in a somewhat lower zone when it is preserved. The somewhat higher freezing temperature zone is a temperature zone higher than −15° C., and the somewhat lower freezing temperature zone is a temperature zone equal to or less than −15° C.

Further, when food is frozen through the supercooled state, ice crystals in the food are made to a small granular shape. As a result, even if a freezing ratio is high, that is, even if a frozen preservation temperature is lower than a conventional one, the food can be cut well with a kitchen knife. More specifically, since the preservation period, during which the food can be preserved in the state that it can be cut with the kitchen knife, is extended, there is a merit in that a novel, functional and high quality freezing temperature zone can be purpued.

Note that although the case in which the supercooling space as the cooling chamber is disposed in the switching chamber 200 has been explained, the supercooling space may be disposed in any of the refrigerating chamber 100, the freezing chamber 300, the vegetable chamber 400, the ice making chamber 500, and the like of the refrigerator in FIG. 3. Further, these chambers may be partly or entirely used as the supercooling space. Further, the supercooling space may be formed as an independent sealed space in the freezing temperature zone. However, it is preferable to employ a structure for preventing strong cold air from being directly applied to the supercooling space or to the food accommodated therein or to permit the amount of cold air flowing into the supercooling space to be adjusted in any of the cases.

In the refrigerator of the present invention, it is possible to obtain a refrigerator capable of performing the supercooled freezing by partly modifying the specification of an ordinary refrigerator. Further, the structure of the home refrigerator has been mainly explained above. However, it is also possible to apply the structure of the present invention to a business-use ultra low temperature refrigerated warehouse based on the concept of the invention. More specifically, it is possible to control the business-use refrigerated warehouse in, for example, such a manner that after food is accommodated, the temperature is lowered to a freezing point at a predetermined cooling speed, then, the food is cooled so as to be kept in a supercooled state while gradually lowering the temperature thereof making use of an airflow having a good temperature distribution in its entirely at a high freezing temperature, the food is quickly frozen by being directly blown with an airflow having a lower temperature after a predetermined time to stop a supercooled state, and thereafter the food is preserved at a temperature lower than the temperature for obtaining the supercooled state, for example, at a freezing temperature of about −18° C. As a result, energy can be greatly saved by the above operation.

Further, the above structure can be more effectively applied when food is caused to enter to the supercooled state while it is being carried by a low temperature carrier acting as a refrigerator, kept in the supercooled state, released from the supercooled state by being directly supplied with cold air having a lower temperature, and preserved in a frozen state. More specifically, in meats, fishes, and the like, since the respective cells thereof and the portions between the cells thereof are filled with water without intervals, they correspond to a vessel filled with water without intervals. As a result, they are not released from the supercooled state by the vibration while they are being transported. Further, when food at a room temperature is accommodated, it is sufficient to cool the food at a temperature which is not too low and finally to freeze it at a freezing temperature of about −20° C. at the lowest without using an extremely low temperature such as −60° C. and the like as in a business-use freezing chamber. Accordingly, the embodiment is useful to save energy consumed by the carrier before and after the food is transported because the food is subjected to the supercooled freezing making use the time during which it is being transported. As a result, the frozen food of good quality can be delivered to a destination.

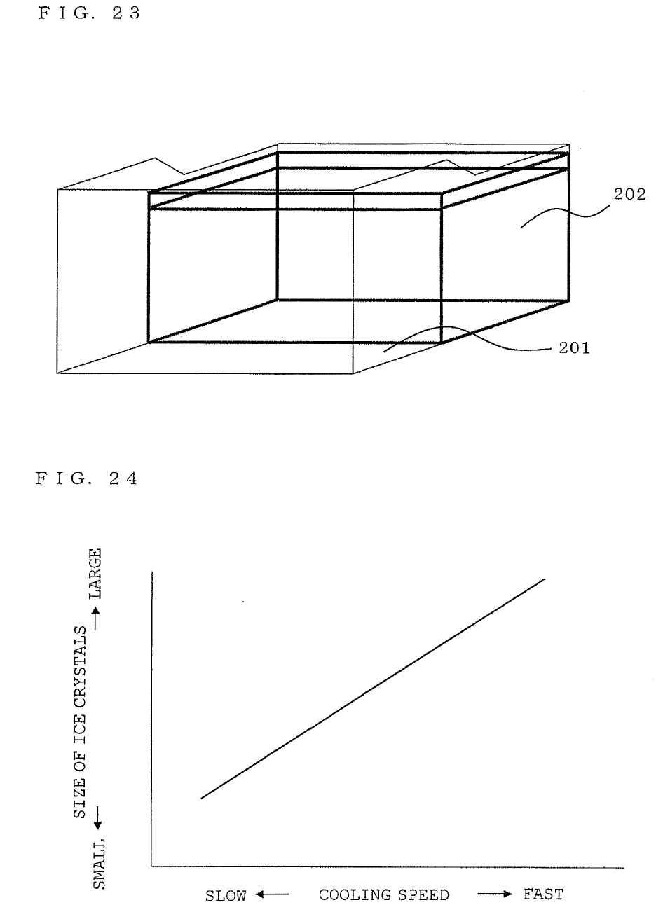

A supercooled state is created at a slow cooling speed in the food subjected to the supercooled freezing in the refrigerator of the present invention. As a result, since ice crystals begin to be created simultaneously after the temperature of the food is uniformly lowered up to the inside thereof, partially created ice crystals are not grown unevenly, and the size of the ice crystals created in the food is small, thereby the quality of the food can be kept. FIG. 24 shows the relation between a cooling speed and the size of ice crystals in the inside of food. It can be found from FIG. 24 that there is a tendency that a higher cooling speed more increases the size of ice crystals created in the inside of food.

The refrigerator of the present invention can realize high quality freezing while saving energy because the refrigerator includes the freezing chamber, which can continuously or stepwise adjust the temperature of the food accommodated therein from 0° C. to the temperature of the freezing temperature zone by the cold air circulating from the cooler, the cooling chamber, which is disposed in the freezing chamber for keeping the food in the supercooled state in which it is not frozen at a temperature equal to or less than the freezing point by taking thereinto the cold air blown out from the cold air blowing port of the freezing chamber and sucked into the cooler, the temperature setting means for setting the temperature of the freezing chamber to −2° C. to −15° C. so that the food stored in the cooling chamber gets the supercooled state, and the cold air adjustment means for adjusting the cold air blown into the freezing chamber and taken into the cooling chamber so that the food stored in the cooling chamber is kept in the supercooled state by suppressing the air velocity around the periphery of the food accommodated in the cooling chamber.

The refrigerator of the present invention can realize high quality freezing while saving energy by the simple structure because the refrigerator includes the freezing chamber for freezing the food accommodated therein by the cold air from the cooler, the cooling chamber disposed in the freezing chamber, for keeping the stored food in the supercooled state, in which the food is not frozen even at a temperature equal to or less than the freezing point, by taking therein the cold air blown out from the cold air blowing port of the freezing chamber and sucked into the cooler, wherein the cooling chamber is composed of the lower case covered with the upper case disposed in the freezing chamber, and a gap formed between the upper case and the lower case to take cold air therein, and wherein the gap is an opening facing a direction different from the flow direction of the cold air flowing in the freezing chamber and has a size of about 10 mm to about 30 mm.

The refrigerator of the present invention includes the supercooling chamber, which keeps the food accommodated therein in the supercooled state, in which it is not frozen at a temperature set to the freezing point to −15° C., by the cold air from the cooler, the cold air adjustment means, which changes the temperature of the cold air blown out into the supercooling chamber and circulating therein, and the supercooled state stopping means, which stops the supercooled state of the food accommodated in the supercooling chamber and placed in the supercooled state by supplying cold air having a temperature about 2° C. to about 5° C. lower than a set temperature by the cold air adjustment means, so that frozen food of good quality can be easily obtained

When the food at a room temperature accommodated in the cooling chamber is cooled, the temperature setting means of the present invention for setting the temperature of the freezing chamber or the cooling chamber sets the cooling speed of the food within the range of −3.5° C./hr to −10° C./hr during the period when the surface temperature of the food is lowered from 3° C. to 0° C., thereby the supercooled state can be securely entered.

The cold air adjustment means for adjusting cold air is disposed to at least any of the cold air blowing port for blowing out cold air into the freezing chamber or into the cooling chamber of the present invention, a cold air taking-in port for taking cold air into the cooling chamber, and the air duct between the cold air blowing port and the cold air taking-in port so that the air velocity around the periphery of food to be placed in the supercooled state, is suppressed to about 0.1 m/s to 0.5 m/s, by adjusting the cold air by the cold air adjustment means, thereby the supercooled state can be kept.

The cold air adjustment means of the present invention forms a plurality of bent portions to the air duct between the cold air blowing port and the cold air taking-in port or provides a duct length corresponding to the depth of the cooling chamber. Otherwise, the cold air adjustment means suppresses the air speed of the cold air blown out into the freezing chamber or into the cooling chamber to about 1.0 m/s to 1.2 m/s at the cold air blowing-out port by the damper, thereby the supercooled state can be kept.

When the temperature of food becomes equal to or less than the temperature previously set as the freezing point of the food or when a predetermined time passes after food is stored in the cooling chamber, the temperature setting means of the present invention for setting the temperature of the freezing chamber or the cooling chamber lowers the temperature of the freezing chamber or the cooling chamber, which is set to the freezing temperature zone from the freezing point to −17° C., by about 1° C. to about 2° C., so that the supercooled state of the food is made deeper. Thereby the frozen quality of the food can be improved.

When stored food is placed in the supercooled state, the cold air adjustment means of the present invention adjusts the fluctuation range of the air temperature around the periphery of the food, which is fluctuated by the change of cooled state, within 10° C. or less or adjusts the unevenness of air temperature in the cooling chamber within 2° C. or less, thereby the supercooled state can be kept.

When a predetermined time passes since the food of the present invention is accommodated or when the abrupt change of the food temperature is detected, since the food in the freezing chamber or the cooling chamber stops the supercooled state by applying a physical shock such as a temperature, a vibration, an ultrasonic wave, and the like thereto and is preserved at a previously set freezing temperature or quickly frozen, thereby the quality of the frozen food can be improved. The supercooling can be stopped simply by directly introducing cold air into the cooling chamber.

In a refrigerator including a cooling chamber for keeping an accommodated food in a supercooled state, in which the food is not frozen at a temperature set from a freezing point to −15° C. and cold air adjustment means for changing the temperature of the cold air blown into the cooling chamber and circulating in a supercooling chamber, the frozen food preservation method of the present invention has a step of accommodating the food the cooling chamber at a temperature set to −15° C., a step of performing adjustment for a predetermined time by cold air adjustment means so that the temperature in the cooling chamber becomes −5° C. to −10° C. or the air velocity in the cooling chamber becomes 0.5 m/s or less, and a step of stopping the supercooled state of the food by directly supplying cold air at a temperature 2° C. to 5° C. lower than the set temperature to the food which is accommodated the cooling chamber and placed in the supercooled state. As a result, in a refrigerator mounted on a vehicle such as a freezer vehicle, it is possible to deliver frozen and reserved foods of good quality to a destination by freezing them with a small amount of energy in the midway of transportation which takes a long time or when necessary, and thus it possible to apply the refrigerator of the present invention to a wide variety of businesses.

Since indirect cooling is performed to create the supercooled state in the refrigerator according to the embodiment, it can be reduced that food is dried by being directly blown with cold air, and the damage of food due to freezing can be also suppressed. Since the cooling speed, which is an important condition to create the supercooled state, is slower than conventional quick freezing, the fluctuation of temperature is reduced, and thus food can be uniformly cooled in its entirety.

Since the refrigerator according to the embodiment is equipped with the supercooling case including the substance having a large heat capacity to suppress the fluctuation of temperature or including a structure for preventing a blown out airflow from directly flowing thereinto, the refrigerator is not affected by the fluctuation of temperature caused by opening and closing the door, from which the temperature in the supercooling case can be stably kept.

Since the refrigerator according to the embodiment changes the temperature on the low temperature side only during stopping the supercooled state, the influence on the existing space such as the switching case and the like can be minimized. As a result, it is possible to use the space or the case set to other temperature zone at the same time.

Further, in the refrigerator according to the embodiment, since the supercooled state can be stopped at a temperature of −2° C. or less (for example, −5° C. or less), energy is less consumed than quick freezing which is a supercooled state stopping method of a conventional embodiment, and thus the refrigerator is excellent in an energy saving property.

In addition to the above-mentioned, since the refrigerator according to the embodiment can selectively set the preservation temperature after stopping the supercooled state, to software freezing, long period freezing, and the like according to the actually used state of the refrigerator, the refrigerator has a merit in that it can be conveniently used.

The refrigerator of the present invention includes the first temperature setting means for setting the temperature of the cooling chamber and placing food in the supercooled state by the cold air introduced into the cooling chamber, the second temperature setting means for stopping the supercooled state of the food by a temperature lower than the temperature of the cooling chamber set by the first temperature setting means, and the third temperature setting means for preserving the food in the frozen state after stopping the supercooled state, and the temperatures set by the first temperature setting means, the second temperature setting means, and the third temperature setting means are sequentially changed at time intervals or by measuring the temperature of the food. As a result, it is possible to perform freeze preservation that consumes a small amount of energy by a simple structure.

The refrigerator of the present invention includes the first temperature setting means for setting the temperature of the cooling chamber to place food in the supercooled state by the cold air introduced into the cooling chamber, the supercooled state stop means for stopping the supercooled state of the food by cold air whose temperature is lower than the temperature of the cooling chamber set by the first temperature setting means, and the third temperature setting means for freezing and preserving the food whose supercooled state is stopped by the supercooled state stop means, and the temperature of the cooling chamber, which is set by the third temperature setting means, can be set with no relation with the temperature of the cooling chamber set by the first temperature setting means. As a result, freeze preservation can be flexibly performed.

The refrigerator of the present invention includes the first temperature setting means for setting the temperature of the cooling chamber to place food in the supercooled state by the cooled wall surface of cooling chamber, the supercooled state stop means for stopping the supercooled state of the food by introducing cold air at a temperature lower than the temperature of the cold air introduced into the cooling chamber for placing the food in the supercooled state or introducing cold air with an air velocity faster than the air velocity around the periphery of the food, and the third temperature setting means for freezing and preserving the food by the cold air introduced into the cooling chamber whose supercooled state is stopped by the supercooled state stop means. As a result, it is possible to perform freeze preservation that consumes a small amount of energy by a simple structure.

Since the refrigerator of the present invention includes the temperature setting means for changeably setting the temperature of the cooling chamber set by the third temperature setting means of the present invention, there can be obtained the conveniently usable refrigerator capable of changing a preservation temperature depending of a type of food.

As described above, the present invention includes the supercooling chamber, which is disposed to the refrigerator main body for storing foods, in which food such as fishes, meats, vegetables, fruits, and the like are accommodated, and which is cooled to the supercooled state by being set to the temperature equal to or less than 0° C. by the cold air from the cooler, and the controller for slowly cooling the supercooling chamber at a first temperature, which is lower than 0° C. and higher than the set temperature, until the time when the core temperatures of the foods becomes approximately the freezing temperatures (freezing points, ice-freezing points) and then slowly cooling the supercooling chamber up to the supercooled state lowest reach temperature so that the supercooled state, in which the foods are not frozen at a temperature equal to or less than the freezing temperature, can be kept at a second temperature lower than the first temperature.

Further, when the core temperatures of the foods accommodated in the supercooling chamber are lowered below approximately the freezing temperature, and thereafter increase to approximately the freezing temperature and the supercooled state is stopped, the controller of the present invention perfectly freezes the foods quickly at the second temperature or at a temperature lower than the second temperature by increasing the amount or the velocity of cooling air.

As described above, the present invention changes the temperature set control continuous or stepwise in the respective steps to the freezing point of foods, from the freezing point the supercooled state lowest reach point temperature, to stopping of the supercooled state and to the perfect freezing. For example, the supercooled state is securely achieved by controlling the temperature, the amount, and the velocity of cold air supplied to the supercooling case, the supercooled state lowest reach temperature thereof is lowered, the supercooled state is stopped, and a freezing speed is increased after stopping the supercooled state to thereby realize freezing of good quality.

Accordingly, since the refrigerator of the present invention employs the supercooled freezing function as a high quality freezing function in place of the conventional quick freezing, the refrigerator has an advantage in that it can realize high quality freezing, that is, ecological freezing with the amount of energy smaller than that in the conventional refrigerator.

Further, the refrigerator of the present invention employs the novel supercooling chamber structure or the novel supercooling chamber case structure which can inhibit cold air from being directly brown into the space for creating the supercooled state, create a uniform temperature, and change a cooling temperature stepwise in a plurality of steps. As a result, the refrigerator of the present invention has an effect in that it can realize supercooled freezing of food by the structure and the control of the refrigerator which are not greatly different from those of the conventional refrigerator.

Note that the refrigerator and the freeze preservation method of the present invention can not only realize high quality freezing that consumes a small amount of energy in a home refrigerator but also can preserve foods in a frozen state for a long period without breaking cells by a simple structure and control. Accordingly, it can be estimated that the refrigerator and the freeze preservation method of the present invention can be usefully applied to a wide fields not only in the large-scale long-term preservation of meats in a business-use refrigerated warehouse and the like and the freeze preservation of fishes caught in deep sea fishery in a vessel but also in the transportation of internal organs in a medical field, medical study equipment in which cells and the like are treated, and the like.

1-30. (canceled)

31. A refrigerator comprising:
a cooler;
a storage chamber where cold air from the cooler flows into; and
a controller for controlling the cold air flowing into the storage chamber to stepwise or continuously lower a temperature of foods stored in the storage chamber and controlling a temperature of the storage chamber so that a supercooled state is achieved, in which the foods are not frozen even at a temperature equal to or less than a freezing point,
wherein the controller stepwise or continuously lowers the temperature of the foods from the freezing point to a predetermined temperature to keep the foods under the supercooled state for a predetermined time, thereafter stops the supercooled state to increase an amount or a velocity of the cold air flowing into the storage chamber and freezes the foods by a rapid cooling.

32. A refrigerator comprising:
a cooler;
a storage chamber where cold air from the cooler flows into;
an accommodation case in which a cold air flow amount from the cooler is limited, the case accommodating foods disposed in the storage chamber; and
a controller for controlling the cold air flowing into the accommodation case to stepwise or continuously lower a temperature of foods stored in the accommodation case and controlling a temperature of the accommodation case so that a supercooled state is achieved, in which the foods are not frozen even at a temperature equal to or less than a freezing point,
wherein the controller stepwise or continuously lowers the temperature of the foods from the freezing point to a predetermined temperature to keep the foods under the supercooled state for a predetermined time, thereafter stops the supercooled state to increase an amount or a velocity of the cold air flowing into the accommodation case and freezes the foods by a rapid cooling.

33. The refrigerator of claim 31, wherein;
the controller gradually cools the storage chamber or accommodation case where the foods are stored at a first temperature which is lower than 0° C. and higher than a set temperature to be supercooled until a food core temperature reaches a freezing point, and when it is judged that the food core temperature reaches the freezing point, gradually cools by a second temperature which is lower than the first temperature so that the supercooled state can be kept where no freezing occurs even the freezing point and under.

34. The refrigerator of claim 32, wherein;
the controller gradually cools the storage chamber or accommodation case where the foods are stored at a first temperature which is lower than 0° C. and higher than a set temperature to be supercooled until a food core temperature reaches a freezing point, and when it is judged that the food core temperature reaches the freezing point, gradually cools by a second temperature which is lower than the first temperature so that the supercooled state can be kept where no freezing occurs even the freezing point and under.

35. The refrigerator of claim 33, wherein;
the controller rapidly cools the storage chamber or accommodation case where the foods are stored at a temperature equal to the second temperature or less, when the food core temperature increases up to the freezing point and the supercooled state is stopped after the foods is turned into the supercooled state.

36. The refrigerator of claim 34, wherein;
the controller rapidly cools the storage chamber or accommodation case where the foods are stored at a temperature equal to the second temperature or less, when the food core temperature increases up to the freezing point and the supercooled state is stopped after the foods is turned into the supercooled state.

37. The refrigerator of claim 31, wherein the supercooled state is kept for at least 5 seconds.

38. The refrigerator of claim 32, wherein the supercooled state is kept for at least 5 seconds.

39. The refrigerator of claim 32, wherein
an upper case and a lower case are installed in a two-stage fashion in the storage chamber and the lower case is made to be the accommodation case.

40. The refrigerator of claim 39, wherein
a gap is disposed between the upper case and the lower case.

41. The refrigerator of claim 39, wherein;
a member to suppress fluctuations of an air temperature in the lower case is disposed on the bottom of the upper case.

42. The refrigerator of claim 40, wherein;
a member to suppress fluctuations of an air temperature in the lower case is disposed on the bottom of the upper case.

43. The refrigerator of claim 31, wherein
a fan is disposed on an upper portion of the storage chamber.

44. The refrigerator of claim 32, wherein
a fan is disposed on an upper portion of the storage chamber.
